(19) United States
(12) Patent Application Publication
(10) Pub. No.: US 2019/0260940 A1
(43) Pub. Date: Aug. 22, 2019

(54) DYNAMIC CAMERA OBJECT TRACKING

(71) Applicant: PERSPECTIVE COMPONENTS, INC., Albuquerque, NM (US)

(72) Inventors: Erik C. Strobert, JR., Albuquerque, NM (US); Beau T. Kujath, Albuquerque, NM (US)

(73) Assignee: PERSPECTIVE COMPONENTS, INC.

(21) Appl. No.: 16/281,757

(22) Filed: Feb. 21, 2019

Related U.S. Application Data
(60) Provisional application No. 62/633,716, filed on Feb. 22, 2018.

(51) Int. Cl. H04N 5/232; G06T 7/20; G06T 7/70; G06K 9/00

(52) U.S. Cl. CPC H04N 5/23296; H04N 5/23299; G06K 9/00496; G06T 7/70; G06T 7/20

(57) ABSTRACT

The present disclosure generally relates to methods and systems for adjusting an image from a mobile device with a motion adjustment module. A method of adjusting a field of view of a camera in a mobile device during image capture is disclosed. The method includes detecting by a processing element an object within an image captured by the camera; determining by the processing element an object boundary surrounding the object; determining by the processing element a position of the object boundary relative to an image frame; determining by the processing element a distance from the object boundary to a selected region; comparing by the processing element the distance to a distance threshold, and based on the comparison; outputting by the processing element a control signal to adjust a physical position of the camera; and recording by the processing element a position of the actuator.

### CROSS-REFERENCE TO RELATED APPLICATIONS

The present application claims priority under 35 U.S.C. § 119 to U.S. provisional patent application No. 62/633,716 filed 22 Feb. 2018 and titled, “Motorized Camera Mount Component for a Smartphone,” the entirety of which is incorporated herein by reference for all purposes.

This application is related to the international patent application no. PCT/US2019/018949 filed 21 Feb. 2019 and titled, “Dynamic Camera Adjustment Mechanism and Methods”; and U.S. patent application Ser. Nos. 16/281,734 filed 21 Feb. 2019 and titled “Dynamic Camera Adjustment Mechanism”; and Ser. No. 16/281,775 filed 21 Feb. 2019 and titled “Methods for Dynamic Camera Position Adjustment” the entireties of which are incorporated herein by reference for all purposes.

### TECHNICAL FIELD

The technology described herein relates generally to systems and methods for dynamic camera and image adjustment and correction.

### BACKGROUND

Smart phones and other mobile devices are common in people's lives and have a variety of uses beyond taking and making telephone calls. For example, many smart phones have one or more embedded cameras capable of capturing images (both photos and video). Users use smart phones and other mobile devices to take pictures and video of their everyday lives. As smart phones and other mobile devices become ubiquitous, they are frequently the cameras of choice, because they are compact, readily available, and easily connected to social media and other networks to allow for simple, and effective sharing and backup of pictures and video.

Traditionally, however, smart phone cameras are deficient at capturing images of moving scenes. For example, generally smart phones are not compatible with traditional tripod or monopod mounts. Specialized smart phone mounts, tripods, monopods, and active image stabilizers have been developed, but these solutions tend to be cumbersome, bulky, heavy, and contrary to the spontaneous nature of much smart phone photography and videography. In other words, people usually do not have, nor want to carry, a bulky image stabilizer for the candid image captures frequently associated with smart phones.

Additionally, smart phone cameras may have small maximum apertures, that limit the amount of light passing through the lens optics to the image sensor. In order to overcome this limitation, the shutter speed or pixel activation sequence (e.g., rolling shutter), of the image sensor may be reduced or otherwise varied allowing a longer exposure. However, typically longer exposure times tend to result in images that capture motion of the subject and/or the camera, as blur or other image artifacts. Blur can be more pronounced in low light conditions, with fast-moving subjects and unsteady camera operators. While blur can have a desired artistic effect, more frequently it is associated with poor image quality. Another solution to capturing images in low light or with fast moving subjects is to enhance the sensitivity (frequently called ISO after the International Organization of Standardization) of the image sensor. Increasing the ISO can reduce blur, because the image sensor is more sensitive to the light incident upon it. This increased sensitivity may then allow a user to use faster shutter speeds. However, often increased ISO comes at the cost of increased image noise, reduced dynamic range, and poorer color reproduction, all resulting in poorer images.

### SUMMARY

The present disclosure generally relates to systems and methods for stabilizing or correcting the position of an image sensor, or camera, and the images captured therefrom.

A motion adjustment module coupled to a mobile device having an acceleration sensor is disclosed. The motion adjustment module includes: a camera; a first mount, coupled to the camera; a second mount, pivotally coupled to the first mount, such that the first mount pivots relative to the second mount; a third mount, pivotally coupled to the second mount; a first actuator in communication with a processing element, that pivots the first mount relative to the second mount about a first axis in response to a first signal received by the processing element from the acceleration sensor, wherein the processing element is in communication with the acceleration sensor; and a second actuator that pivots the second mount about a second axis in response to a second signal received by the processing element from the acceleration sensor.

A motion adjustment module coupled to a mobile device having an acceleration sensor is disclosed. The motion adjustment module includes: a camera; a tilt mount, coupled to the camera; a pan mount, pivotally coupled to the tilt mount, such that the tilt mount pivots relative to the pan mount; a stationary mount, pivotally coupled to the pan mount; a tilt actuator in communication with a processing element, that pivots the tilt mount relative to the pan mount about a tilt axis in response to a first signal received by the processing element from the acceleration sensor, wherein the processing element is in communication with the accelerations sensor; and a pan actuator that pivots the pan mount about a pan axis in response to a second signal received by the processing element from the acceleration sensor.

A method of a processing element adjusting a position of a camera within a mobile device is disclosed. The method includes: receiving from an acceleration sensor an initial motion data corresponding to a first motion of the mobile device at a first time period; recording the initial motion data in a memory; receiving from the acceleration sensor a current motion data corresponding to a second motion of the mobile device at a second time period; determining a change in motion data from the initial motion data to the current motion data corresponding to a change in motion of the user device from the first time period to the second time period; and comparing the change in motion data to a threshold, and based on the comparison, rotating an actuator coupled to the camera about a first actuator axis, wherein the rotation of the actuator about the first actuator axis rotates the camera about a first camera axis to compensate for the change in motion of the mobile device.

A method of compensating, with a processing element, for device motion during image capture is disclosed. The method includes:determining a change in motion data from an initial position; comparing the change in motion data to a threshold; outputting a control signal to a first actuator, wherein the control signal is based on the comparison between the change in motion data and the threshold; and rotating the first actuator, wherein the first actuator rotates a first mount holding a camera to compensate for the change in motion.

A method of adjusting a field of view of a camera in a mobile device during image capture is disclosed. The method includes: detecting by a processing element an object within an image captured by the camera; determining by the processing element an object boundary surrounding the object; determining by the processing element a position of the object boundary relative to an image frame; determining by the processing element a distance from the object boundary to a selected region; comparing by the processing element the distance to a distance threshold, and based on the comparison; outputting by the processing element a control signal to adjust a physical position of the camera; and recording by the processing element a position of the actuator.

A method of adjusting an image from a mobile device is disclosed. The method includes: receiving rotation data by a processing element from an acceleration sensor; setting an initial rotation data; determining a current rotation data; determining a change in the rotation data; and comparing the change in rotation data to a threshold, and based on the comparison, adjusting the image.

A method to maintain a selected object within a field of view of a camera in a mobile device is disclosed. The method includes: detecting by a processing element, an object within an image captured by the camera; tracking by a processing element a distance of the object relative to an image boundary; outputting a movement signal to a first actuator on a first mount, wherein the first mount tilts or pans the camera; and moving the first actuator to adjust a position of the camera to keep the object within the image boundary.

### BRIEF DESCRIPTION OF THE DRAWINGS

FIG. 1A is a front view of an example of a motion adjustment module mounted to a mobile electronic device, such as a smart phone.

FIG. 1B is a front, right isometric view of an example of the motion adjustment module of FIG. 1A.

FIG. 1C is a front, right isometric view of an example of a motion adjustment module enclosed within a mobile electronic device, such as a smart phone.

FIG. 2 is a front, right isometric view of the motion adjustment module with the enclosure removed.

FIG. 3 is an exploded isometric view of an example of a motion adjustment module.

FIG. 4A is an upper, right isometric view of an example of a motion adjustment module.

FIG. 4B is a front elevation view of the motion adjustment module of FIG. 4A.

FIG. 4C is a left elevation view of the motion adjustment module of FIG. 4A.

FIG. 5 is a simplified block diagram of the a camera adjustment system including the motion adjustment module.

FIG. 6A is a front, right isometric view of an example of a primary mount of a motion adjustment module.

FIG. 6B is a front elevation view of the primary mount of FIG. 6A.

FIG. 6C is a top view of an example of a primary mount of FIG. 6A.

FIG. 7A is a rear, top perspective view of an example of a secondary mount of a motion adjustment module.

FIG. 7B is a right elevation view the secondary mount of FIG. 7A.

FIG. 7C is a rear view the secondary mount of FIG. 7A.

FIG. 7D is a left elevation view the secondary mount of FIG. 7A.

FIG. 8A is a top, rear isometric view of an example of a tertiary mount of a motion adjustment module.

FIG. 8B is a right elevation view the tertiary mount of FIG. 8A.

FIG. 8C is a rear elevation view the tertiary mount of FIG. 8A.

FIG. 8D is a left elevation view the tertiary mount of FIG. 8A.

FIG. 8E is a bottom elevation view the tertiary mount of FIG. 8A.

FIG. 9A is an isometric view of an example of a primary mount driving portion.

FIG. 9B is an isometric view of an example of a secondary mount driving portion.

FIG. 9C is an isometric view of an example of a primary mount driven portion.

FIG. 9D is an isometric view of an example of a secondary mount driven portion.

FIG. 10 is a partial schematic view illustrating a method of using a motion adjustment module to adjust for camera movement.

FIG. 11 is a flow chart illustrating the method of utilizing a motion adjustment module to adjust the camera to compensate for movement.

FIG. 12 is a partial schematic view illustrating a method of using a motion adjustment module to track the movement of a subject using a motion adjustment module.

FIG. 13 is a flow chart illustrating a method to follow subject movement during image or video capture using a motion adjustment module.

FIG. 14 is a flow chart illustrating a method of compensating for rotation of a camera during image capture.

FIG. 15A is a side view of a motion adjustment module in a first configuration.

FIG. 15B is a side view of a motion adjustment module in a second configuration.

FIG. 15C is a top, isometric view of a motion adjustment module in a first configuration.

FIG. 15D is a top, isometric view of a motion adjustment module in a second configuration.

FIG. 16A is a front view of an example of a motion adjustment module.

FIG. 16B is a front top isometric view of the motion adjustment module of FIG. 16A.

FIG. 17A is a partial section view of the motion adjustment module of FIG. 16A along section line 17-17 in a first configuration.

FIG. 17B is a partial section view of the motion adjustment module of FIG. 16A along section line 17-17 in a second configuration.

FIG. 18A is a front top isometric view of the motion adjustment module of FIG. 16A in a first configuration.

FIG. 18B is a front top isometric view of the motion adjustment module of FIG. 16A in a second configuration.

FIG. 19A is a front top isometric view of the motion adjustment module of FIG. 16A in a third configuration.

FIG. 19B is a front rear isometric view of the motion adjustment module of FIG. 16A in a fourth configuration.

FIG. 20 is a front top isometric view and partial schematic view of the motion adjustment module of FIG. 16A showing a processing element and actuator drivers.

FIG. 21 is a front top isometric view and partial schematic view of the motion adjustment module of FIG. 16A showing a processing element, actuator drivers, and an acceleration sensor.

FIG. 22 is a front top isometric view of another example of a motion adjustment module.

FIG. 23 is a rear top isometric view of another example of the motion adjustment module of FIG. 22.

FIG. 24 is a front top isometric view of another example of a motion adjustment module.

FIG. 25 is a front top isometric view of another example of a motion adjustment module.

FIG. 26 is an exploded isometric view of the motion adjustment module of FIG. 25.

FIG. 27A is a front, top perspective view of an example of a secondary mount of a motion adjustment module.

FIG. 27B is a rear, top perspective view of the secondary mount of FIG. 27A.

FIG. 27C is a right elevation view of the secondary mount of FIG. 27A.

FIG. 27D is a front elevation view of the secondary mount of FIG. 27A.

FIG. 27E is a left elevation view of the secondary mount of FIG. 27A.

### DETAILED DESCRIPTION

The present disclosure generally relates to systems and methods for stabilizing or correcting the position of an image sensor, or camera module (e.g., lens and image sensor), and the images captured therefrom. In one example, a motion adjustment module includes a camera and can be enclosed within the smart phone or user mobile device or mounted externally to the device. The motion adjustment module adjusts the position of the camera in order to counteract the effects on image quality that may be caused by motion of the camera, the subject, or both.

In one example of a motion adjustment module, the module is a device mountable to the exterior of a smart phone. The motion adjustment module may mount near or over a forward facing camera of the smart phone or at other locations sufficiently near the camera element to be able to physically move the camera or lens. In one example, the motion adjustment module acts to move the camera in a pan direction (e.g., horizontally), a tilt direction (e.g., vertically), and optionally a depth direction. The motion adjustment module has three mounts; primary, secondary, and tertiary. The primary mount holds a camera including an image sensor and lens or other optics and is coupled to the secondary mount at a first pivot. The primary mount pivots about a first axis that may be parallel to a short dimension of the smart phone display and may act to vary the orientation of the camera in the “pan” direction. The primary mount includes a gear driven by a first pinion or other drive mechanism and a first actuator, housed in the secondary mount. The first actuator and first pinion cooperate with the gear to cause the primary mount and camera to pivot about the first axis.

The secondary mount further joins to a tertiary mount by a second pivot. The secondary mount (and the primary mount and camera it holds) pivots about a second axis that may be parallel to a long dimension of the smart phone display and may act to vary the orientation of the camera in the “tilt” direction. The first and second axes are substantially orthogonal to one another, as are the first and second pivots. The secondary mount holds a second actuator with a second pinion or other drive element. The tertiary mount holds an arcuate rack. The arcuate rack cooperates with the second pinion and second actuator to pivot the secondary mount about the second axis. The pivoting motion of the primary and secondary mounts are independent of one another. The tertiary mount releasably attaches to the smart phone, and supports the rest of the motion adjustment module.

The camera is connected electronically to the smart phone by a cable, wires, or optionally wirelessly. The electronic connection transfers image information from the motion adjustment module to one or more processing elements of the mobile device. The connection also transfers actuation commands and power from the mobile device to the first and second actuators.

In one example of a method of using a motion adjustment module with a camera, the motion adjustment module receives position data about the mobile device or the camera from a position sensor. Using this position data, the motion adjustment module adjusts the position of the camera based on changes in the position data, in order to ensure that the physical motion of the camera will compensate (at least substantially) for movement of the mobile device by the user during image capture. In another example of a method of using a motion adjustment module, the motion adjustment module receives image data from a camera, and adjusts the physical orientation of the camera to continue to track an object within the camera frame. In other words, the camera can act to “lock in” on a subject and maintain the subject at a desired location in the frame, compensating for user motion of the camera or electronic device during image capture and/or motion of the subject into and out of fame. In another example of a method of using a motion adjustment module, the motion adjustment module receives image data from a camera, as well as, rotational data about the smart phone or other mobile electronic devices, and adjusts the image rotation for the camera.

### Motion Adjustment Module

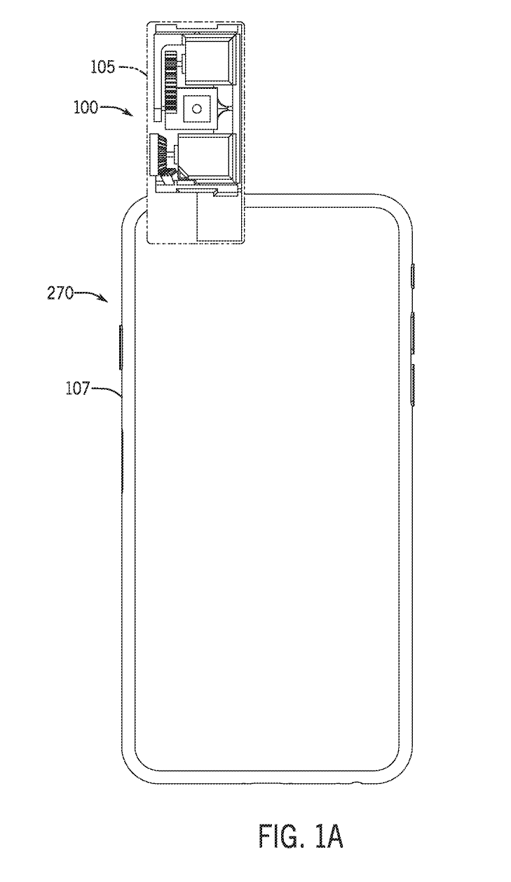

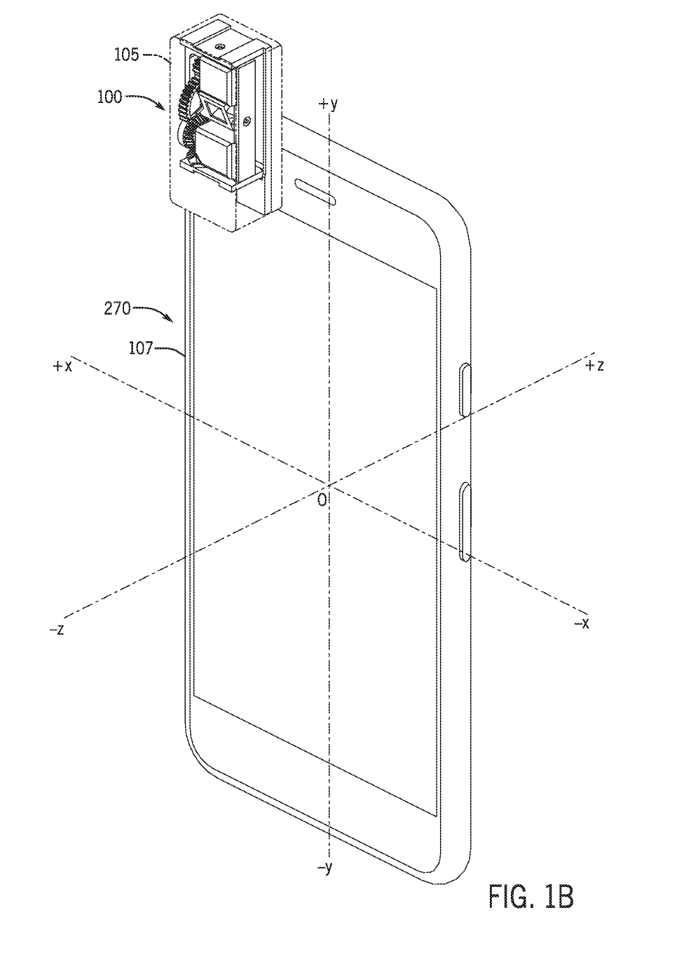

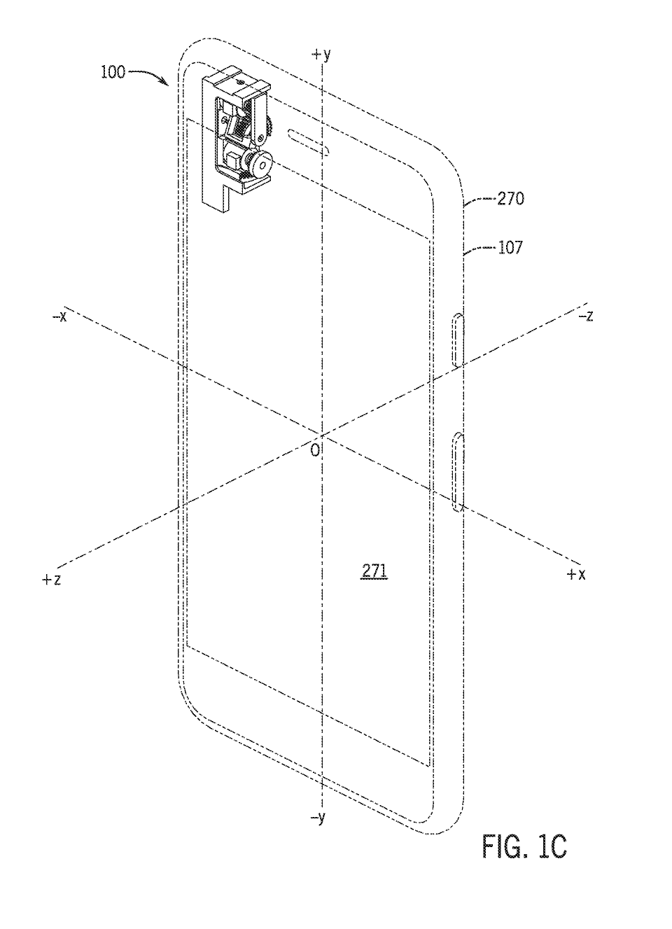

Referring to FIG. 1A, a front view of a motion adjustment module 100 is shown, attached to a user mobile device 270. FIG. 1B shows a front, right isometric view of the motion adjustment module 100 and user mobile device 270 of FIG. 1A. In one example, the user mobile device 270 is a smart phone. In one example, the motion adjustment module 100 is releasably mounted or coupled to the exterior of the user mobile device 270. In another example, the motion adjustment module 100 may be permanently mounted or coupled to the exterior of the user mobile device 270. In other examples, the motion adjustment module 100 may be encased in an enclosure 105 (shown in dashed lines), as shown in FIGS. 1A and 1B. In other examples the user mobile device 270 may be another type of device, such as a media player, game console, camera or other device capable of detecting position information and receiving image information, and in these instances the motion adjustment module may be positioned or attached thereto in a manner that connects the motion adjustment module to the camera.

FIG. 1C illustrates a front, right isometric view of an example of a motion adjustment module embedded or positioned within a user mobile device 270, e.g., within a housing of the user mobile device. Generally, the user mobile device 270 includes a display 271 (e.g., liquid crystal display or the like) and may have a substantially planar shape defined by two substantially orthogonal dimensions. The two dimensions may have different lengths, or they may have the same length. The display may have other shapes, and may be curved, rather than planar. Alternately the display 271 may have planar sections and other sections that are curved. The display 271 may form at least a portion of the mobile device 270 enclosure 107 and optionally may be coupled to a device housing 107. The device housing 107 acts to support and secure the internal components of the mobile device, including the camera, and optionally the adjustment module as shown in FIG. 1C.

FIGS. 1B and 1C show sets of three axes that will be used to describe the relative motion of the components of the motion adjustment module 100. It should be noted that the discussion of any particular direction or relative relationship described herein is meant for illustrative purposes to describe the motion. The x-axis may be parallel to a first dimension of the display 271, which may correspond to a horizontal orientation of the display. In one example, the x-axis is parallel to a short dimension of the display 271. In one example, the x-axis may be a tilt axis. A tilt axis, in one example is an axis where rotation about the tilt axis causes a camera 294 or a mount to rotate up or down relative to the horizon. The y-axis may be parallel to a second dimension of the display 271, which may correspond to a vertical orientation of the display. In one example, the y-axis is parallel to a long dimension of the display 271. In one example, the y-axis may be a pan axis. In one example, a pan axis is one where rotation about the pan axis causes the camera 294 or a mount to rotate to the left or right of the display 271. The x-axis and y-axis may define an xy plane. The z-axis may be parallel to a depth dimension of the display 271. In one example, the z-axis is normal to the surface of the display. In one example, the z-axis is normal to the xy plane. Similarly, the y-axis and z-axis may define a yz plane. The x-axis may be normal to the yz plane. Similarly, the x-axis and z-axis may define an xz plane. The y-axis may be normal to the xz plane. The axes may intersect at a common origin O. Alternately, the axes may not intersect, or two axes may intersect and the third may not intersect the other two. An axis may have a positive indication in one direction relative to a reference point on the axis. An axis may have a negative indication in another direction relative to the reference point on the axis. In one example, the reference point is the origin O. For example, the x-axis may have a positive indication denoted +x in one direction relative to the origin O, and a negative indication denoted −x in an opposite direction relative to the origin O. Similarly, the y-axis may have indications +y and −y. The z-axis may have indications +z and −z. In other examples, the x-axis, y-axis, and z-axis may not be orthogonal to one another. Alternately, two axes may be mutually orthogonal and a third axis may not be orthogonal to either of the other two axes, nor a plane they define. Any of the x-axis, y-axis, and/or z-axis, or any combination thereof may be associated with either the user mobile device 270 or the display 271.

It should be noted that the various axes orientations used herein may typically correspond to the display, which often is used as a viewfinder for the camera and thus a user may generate motion of the user device based on images displayed on the display from the camera. That said, any specific implementation and axes description is meant as illustrative only.

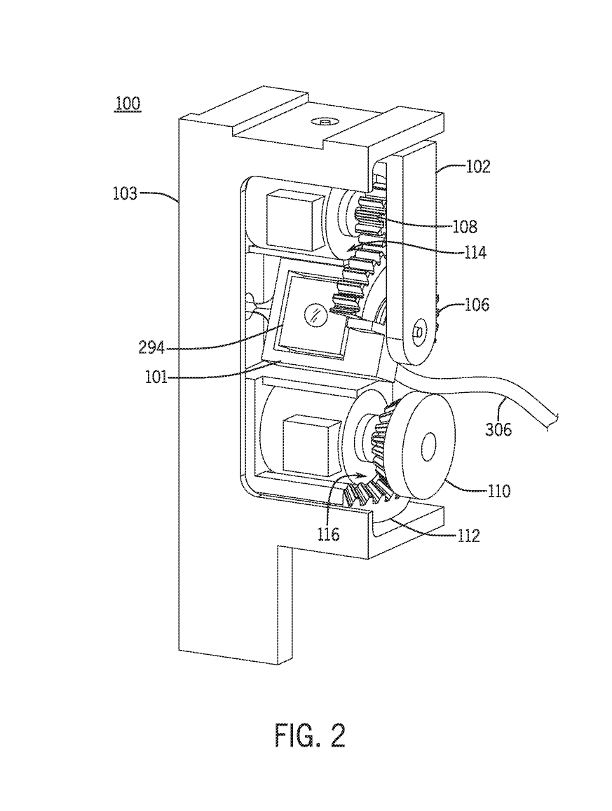

FIGS. 2, 3, and 4A-C illustrate an example of a motion adjustment module with the enclosure removed to illustrate internal components. The motion adjustment module 100 attaches to a camera 294, which is typically one or more onboard cameras of the mobile device (e.g., front and/or rear facing cameras). The motion adjustment module 100 may have a camera 294 in addition to cameras onboard the user mobile device 270. In one example, the motion adjustment module 100 includes a primary or first mount 101, which may act to adjust the camera orientation as a tilt correction, a secondary or second mount 102, which may act to adjust the camera orientation as a pan correction, and a tertiary or third mount 103, which may act to adjust the camera orientation as a spin correction. The motion adjustment module 100 may include one or more actuators, such as a primary mount actuator 114 and a secondary mount actuator 116, which may be coupled to one or more respective driven portions and/or a driving portions. In one example, the motion adjustment module 100 includes a primary mount driving portion 108, a primary mount driven portion 106, a secondary mount driving portion 110, and/or a secondary mount driven portion 112, where the primary mount driving portion 108 drives the primary mount driven portion 106 and the secondary mount driving portion 110 drives the secondary mount driven portion 112.

The motion adjustment module 100, and its constituent components (e.g., the camera 294, the actuators, 114, 116, and various sensors and controllers) may communicate with and/or receive electrical power from the user mobile device 270 via a communications link 306, or via a separate power source. In various examples, the communications link 306 may be a cable, wires, ribbon cable, or flexible circuit board. Alternately, the communications link 306 may be wireless, e.g., Wi-Fi, Bluetooth, near field communications, infrared, or other suitable radio or optically based wireless communications.

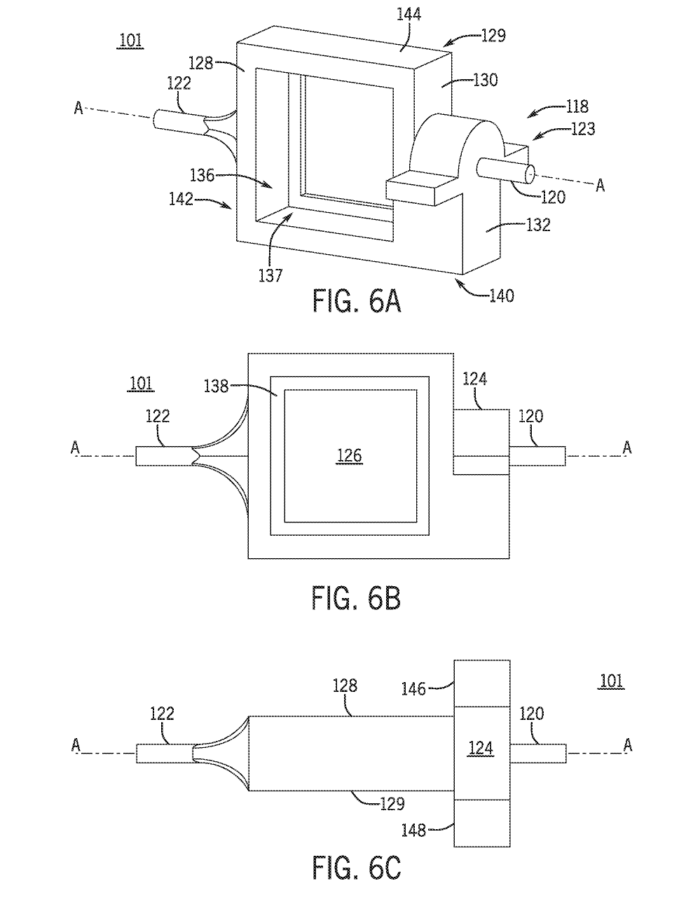

FIGS. 6A-C illustrate an example of a primary mount 101. The primary mount 101 has a body 118 that defines walls enclosing or otherwise defining a three dimensional space. The body 118 has a pivot axis that may be parallel to one of the x-axis, y-axis, or z-axis of the motion adjustment module 100. The primary mount 101 has a seating feature 137, such as a pocket or recess, for receiving a camera or other image sensor. In one example, the body 118 has an upper wall 144, a side wall 142, a bottom wall 140, a plurality of side walls 130, 132; a front face 129 and a rear face 128. The various walls may be cooperate to form a generally square shaped body, but other geometric shapes are envisioned as well. Also, although the body 118 is shown as defining an enclosed region, the body may be open, e.g., include three walls rather than four or otherwise include partial walls.

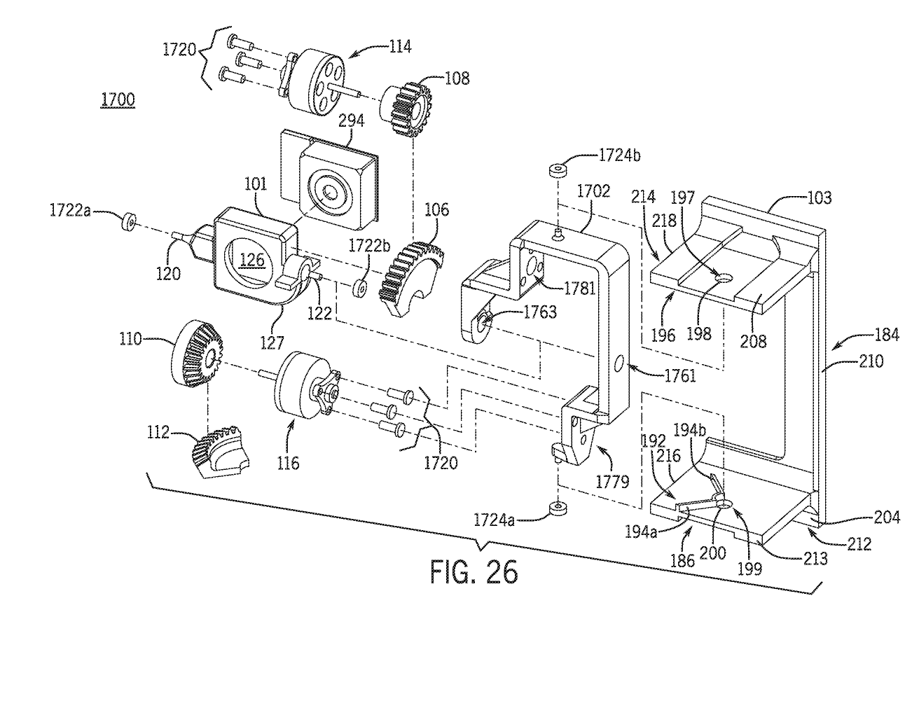

In one example, a cavity 136 may be recessed into the body 118, extending from the rear face 128 toward the front face 129. A camera mounting flange 138 may extend into the cavity 136 at an end proximate to the front face 129. The cavity 136 may be hollow such that an aperture 126 extends from the one end of the cavity 136 through the front face 129. The cavity 136, mounting flange 138, and the aperture 126 cooperate to form the camera receiving feature 137. In this example, the camera seat 137 may be defined as a hollow support bracket. However, the shape of the camera seat 137 or camera receiving feature 137 may be varied depending on the configuration of the camera and lenses and the discussion of any particular configuration is meant as illustrative only. See, for example, FIG. 26 illustrating another example of a primary mount 101 with a substantially round aperture 126, and a rounded edge 127 extending from adjacent to the pivot axis 122.

The primary mount 101 has a gear seat or other feature 123 for receiving a primary mount driven portion. One example of the primary mount driven portion receiving feature 123 is illustrated in FIGS. 6A-C, which includes an arcuate mounting surface 124, side wall 132, and two wings 146 and 148. In this example, the arcuate mounting surface 124 extends outwards from the body 118 at the side wall 130, parallel to a pivot axis A-A. The wings extend laterally, perpendicular to the pivot axis A-A, from the arcuate mounting surface 124.

The body 118 may pivot about the pivot axis at a pivot. In one example, the pivot includes a first and second pivot shafts 120, 122. The first pivot shaft 120 extends parallel to the pivot axis A-A from the side wall 132 away from the body 118. The second pivot shaft 122 extends parallel to the pivot axis A-A from the side wall 142 away from the body 118, in a direction antiparallel to the first pivot shaft 120. The pivot shafts 120, 122 may be substantially cylindrical. Alternately, the pivot shafts 120, 122 may extend from their respective walls with fillets or other transition portions, with substantially cylindrical portions near ends distal from the body 118.

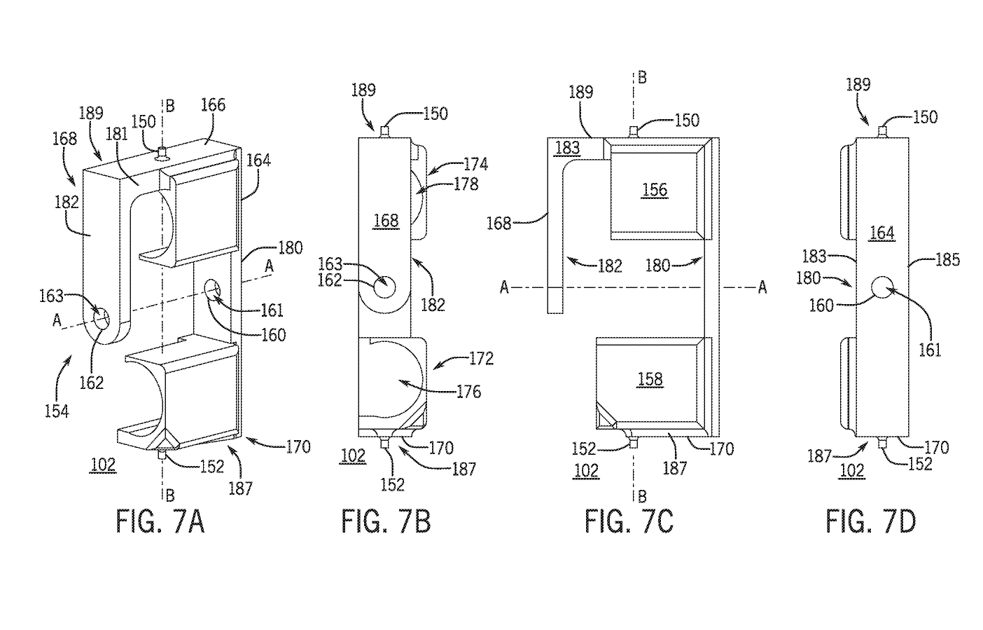

FIGS. 7A-7D illustrate an example of a secondary mount 102. The secondary mount 102 has a body 154 defining walls enclosing a three-dimensional space. In one example, the body 154 has a top wall 166, a side wall 164, an opposing side wall 168, a front wall 185, a rear wall 183, and a lower wall 170. In some embodiments, the body 154 may be shaped as a partial U or O shaped structure.

The body 154 may have two or more pivot axes that may be parallel to axes of the motion adjustment module 100. For example, the body 154 may have a first pivot axis A-A, and a second pivot axis B-B. The A-A and B-B axes may be mutually perpendicular. Either or both of the pivot axes may be parallel to axes of the motion adjustment module 100. In various examples, the A-A pivot axis may be parallel to the x-axis, and the B-B pivot axis may be parallel to the y-axis. Alternately, in various examples, the A-A pivot axis may be parallel to the y-axis, and the B-B pivot axis may be parallel to the x-axis. The pivot axis A-A and/or pivot axis B-B may have some other orientation relative to the x-axis and y-axis.

With continued reference to FIGS. 7A-7D, the body 154 may have a main support frame extending parallel to one of the pivot axes. In one example, a primary support frame 180 extends parallel to the B-B pivot axis, e.g., vertically relative to a height or length of the phone. A lateral support arm 187 extends away from the main support frame. In one example, the body 154 has the lower lateral support arm 187 extends parallel to the A-A pivot axis and extends horizontally from a first end of the main support frame 180. In another example, the body has an upper lateral support arm 189 extending parallel to the A-A pivot axis, from a second end of the main support frame 180 distal from the first end. In this example, the two lateral support arms 187, 189 may define the upper and bottom bracket surfaces for the body 154. In other examples, a lateral support arm may extend from the main support frame at a location not near the end of the main support frame 180, e.g., towards a middle portion. The body 154 may have a hanging support arm extending from a lateral support arm. In one example, a hanging support arm 182 extends downwards from the terminal end of the upper lateral support arm 189 in a direction parallel to the B-B pivot axis. The hanging support arm 182 may extend a portion of the length of the body 154 parallel to the B-B pivot axis. In one example, the hanging support arm 182 may extend for substantially the dimension of the body 154 parallel to the B-B pivot axis. In some instances, the hanging support arm 182 may extend the full length of the body 154 to define a partially enclosed interior space.

The hanging support arm 182 and/or the main support frame 180 include features to receive the primary mount 101. In one example, the hanging support arm 182 has a first primary mount pivot aperture 161 and the main support frame 180 has a second primary pivot mount aperture 163. The first and second primary mount pivot apertures 161, 163 may be substantially cylindrically shaped holes extending through a thickness or a portion of the thickness (e.g., recessed) of the hanging support arm 182 and the main support frame 180, respectively. The first and second primary mount pivot apertures 161, 163 may have first and second bearing surfaces 160 and 162, respectively, that are defined as the interior walls forming the apertures. The bearing surfaces 160, 162 receive and support of a shaft, allowing the shaft to pivot or rotate therein, for example receiving first pivot shaft 120 and a second pivot shaft 122 of the primary mount 101.

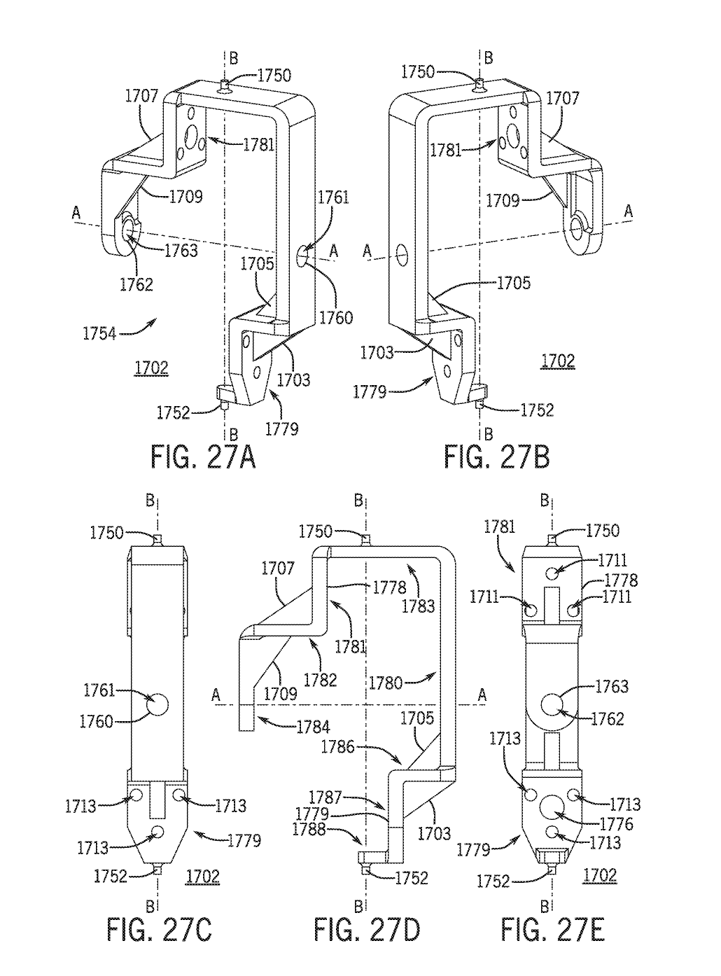

The secondary mount 102 may also include an actuator platform or pocket that receives and supports an actuator. In one example, a primary mount actuator receiving feature 174 may be located adjacent to an intersection between the main support frame 180 and the upper lateral support arm 189. In this example, the primary mount actuator receiving feature 174 includes a prismatic body 156, which may be defined as a generally hollow pocket and include an actuator receiving feature 178 or cavity therein. In one example, the actuator receiving feature 178 a semi-circular cross section and extends into the prismatic body 156 in a direction parallel to the A-A pivot axis. Additionally, a secondary mount actuator receiving feature 172 may be located adjacent to an intersection between the main support frame 180 and the lower lateral support arm 187. In this example, the secondary mount actuator receiving feature 172 includes a prismatic body 158, which may be similar to the prismatic body 156 and include a pocket or actuator cavity defined therein. The actuator receiving feature 176 or pocket may be defined by a semi-circular cross section and extend into the prismatic body 158 in a direction parallel to the A-A pivot axis. In these examples, the two actuator receiving pockets 176 or cavities may be defined in platforms or bodies that extend parallel to one another, such that both actuators, when positioned in the mount, may be aligned in parallel. Alternately, the actuator receiving features 172 and/or 174 may be a flange with a face suitable for mating to an actuator, with one or more fastener apertures extending through a width of the flange and capable of receiving a fastener to hold the actuator to the receiving feature. See, e.g., actuator receiving features 1779 and 1781 of FIGS. 26 and 27 A-E.

The body 154 includes a pivot feature that defines a pivot axis for the body 154. In one example, the pivot feature includes a first pivot shaft 150 and a second pivot shaft 152 that extend from opposite ends of the body 154. In one example, the first pivot shaft 150 extends parallel to the pivot axis B-B from the upper lateral support arm 187 away from the body 154 and the second pivot shaft 152 extends parallel to the pivot axis B-B from the lower lateral support arm away from the body 154, in a direction antiparallel to the first pivot shaft 150. The pivot shafts 150, 152 may be substantially cylindrical or otherwise configured to allow pivoting or rotational motion of the body 154. Alternately, the pivot shafts 150, 152 may extend from their respective support arms with fillets or other transition portions, with substantially cylindrical portions near ends distal from the body 154.

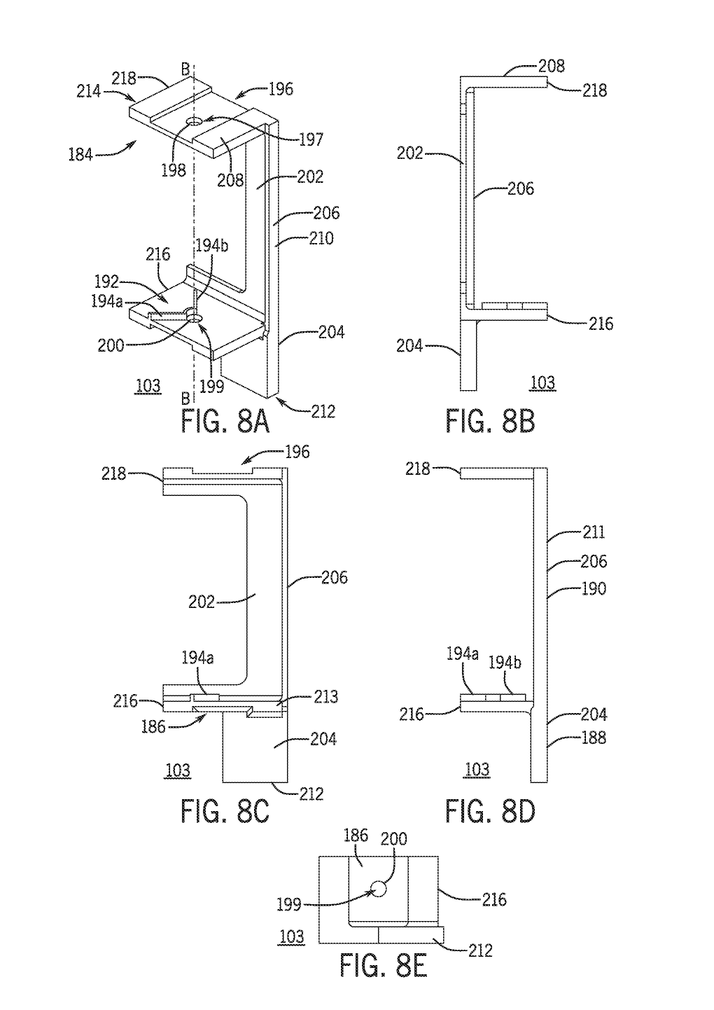

FIGS. 8A-E illustrate an example of a tertiary mount 103. The tertiary mount 103 has a body 184 having walls enclosing a three-dimensional space and may be generally shaped as a vertically defined body with two or more support bars extending horizontally therefrom In one example, the body 184 has a front wall 211, an opposing rear wall 213, a side wall 214, an opposing side wall 210, a lower wall 212, and an upper wall 208. The body 184 has a main support scaffold 190 that defines a vertical or longitudinal length of the body. The body 184 has an axis B-B that supports other mounts, for example secondary mount 102. The main support scaffold 190 may extend parallel to the axis B-B. In one example, the main support scaffold 190 has a first flange 202 and a second flange 206. The first flange 202 extends in a direction perpendicular to the axis B-B. The second flange 206 extends in a direction perpendicular to both the first flange 202 and the axis B-B. In this example, the cross section of the main support scaffold 190 is substantially L-shaped. The flanges 202 and 204 form a supporting and stiffening web between the lateral support arms 216 and 218.

One or more cantilevered support arms may extend from the main support scaffold 190. In one example, a lower cantilevered support arm 216 extends from the main support scaffold 190 in a direction perpendicular to the axis B-B. The lower cantilevered support arm 216 may be located near or at a terminal end of the main support scaffold 190. The lower cantilevered support arm 216 may be located elsewhere along a dimension of the main support scaffold 190 parallel to the axis B-B, distal from an end of the scaffold 190, such as spaced apart from the opposing terminal end of main support scaffold 190. In one example, the main support scaffold 190 has a tang 188 extending below the lower cantilevered support arm 216. An upper cantilevered support arm 218 may extend from the main support scaffold 190 in a direction perpendicular to the axis B-B at a location along the main support scaffold 190 distal from the lower cantilevered support arm 216.

The lower cantilevered support arm 216 may have a secondary mount driven portion support bracket 192 extending from a surface thereof, e.g., an upper interior surface. The secondary mount driven portion support bracket 192 receives and supports a secondary mount driven portion 112. In one example, the secondary mount driven portion support bracket 192 includes a first arm 194a and a second arm 194b that may extend from vertically upwards from a surface of the lower cantilevered support arm 216. The arms 194a and 194b may be arranged so as to form an angle between them that cooperates with the shape of the secondary mount driven portion 112.

The lower cantilevered support arm 216 and/or the upper cantilevered support arm 218 may have a feature to receive the secondary mount 102. In one example, the lower cantilevered support arm 216 has a first secondary mount pivot aperture 199. In one example, the upper cantilevered support arm 218 has a second secondary pivot mount aperture 197. The first and second secondary mount pivot apertures 199, 197 may be substantially cylindrical holes extending through a thickness or partially through the thickness (e.g., recessed) of the upper cantilevered support arm 218 and the lower cantilevered support arm 216, respectively. The first and second secondary mount pivot apertures 199, 197 may have first and second bearing surfaces 200 and 198, respectively, that define the interior walls and the apertures. The bearing surfaces 200, 198 support of a shaft therein, allowing the shaft to pivot or rotate therein, for example first pivot shaft 150 and a second pivot shaft 152 of the secondary mount 102.

The upper cantilevered support arm 218 may have a feature for receiving a housing. In one example, the housing receiving feature is a slot 196 recessed into a face of the upper cantilevered support arm 218. Likewise, the lower cantilevered support arm 216 may have a feature for receiving a housing. In one example, the housing receiving feature is a slot 186 recessed into a face of the lower cantilevered support arm 218.

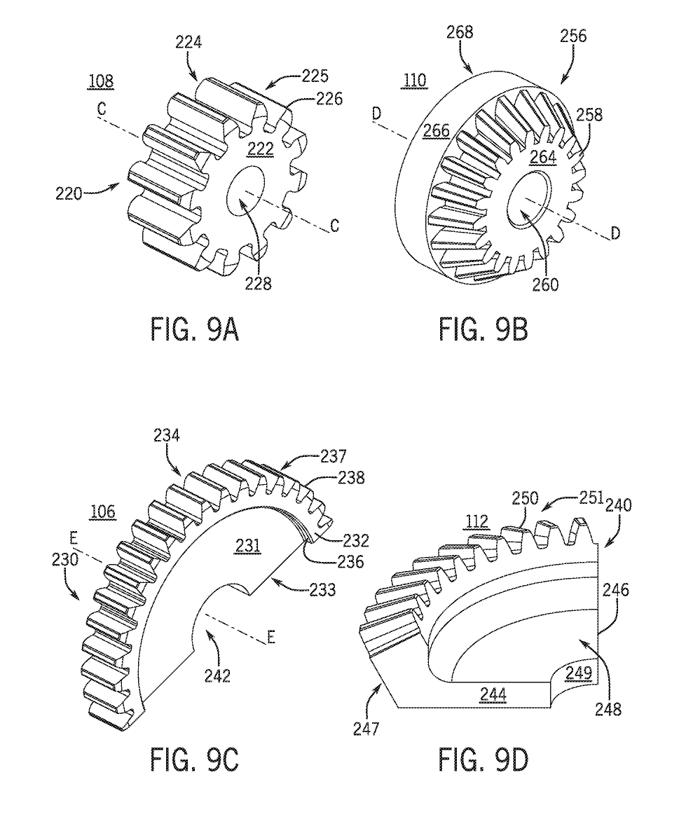

FIG. 9A illustrates an example of a primary mount driving portion 108. The primary mount driving portion 108 has a body 220 that may be substantially cylindrical in shape with a first face 224 and an opposing face 222 spaced axially along an axis C-C. A circumferential face 225 of the body may be defined between the first and second faces. The faces 224 and 222 may have the same diameter, or they may have different diameters. The circumferential face 225 may have a torsional engagement feature 226 for transmitting torque to a cooperating torsional engagement feature. The torsional engagement feature may extend along the entire dimension of the circumferential face 225 between the first face and the second face. Alternately, the torsional engagement feature may extend along a fraction of the dimension between the first face and the second face. In one example, the torsional engagement feature 226 is a plurality of gear teeth. In another example, the torsional engagement feature 226 is a pulley, having a groove of any suitable profile to receive a flexible torsional member such as a belt, gear belt, chain, or the like. In various examples, the plurality of gear teeth define spur gears, helical gears, a rack and pinion, bevel gears, miter gears, a worm and gear, screw gears or the like. The primary mount driving portion 108 may have a shaft receiving aperture 228, couplable to a driving shaft and capable of transmitting torque about the C-C axis to the primary mount driving portion 108.

FIG. 9B illustrates an example of a secondary mount driving portion 110. The secondary mount driving portion 110 has a body 256. The body 256 may be substantially cylindrical in shape with a first face 268 and an opposing face 264 spaced axially along an axis D-D. A circumferential face 266 of the body may be defined between the first and second faces 268, 264. The faces 268 and 264 may have the same diameter, or they may have different diameters. The circumferential face 266 may have a torsional engagement feature 258 for transmitting torque to a cooperating torsional engagement feature. The examples of the torsional engagement feature 258 may be as described in the examples of the torsional engagement feature 226 of the primary mount driving portion 108. The secondary mount driving portion 110 may have a shaft receiving aperture 260, couplable to a driving shaft and capable of transmitting torque about the D-D axis to the secondary mount driving portion 110.

FIG. 9C illustrates an example of a primary mount driven portion 106. The primary mount driven portion 106 has a body 230. The body 230 may be substantially hemicylindrical in shape with a first face 234, an opposing face 232, and a face 233 aligned with a cord of the body 230. The first face 234 and the opposing face 232 may be spaced axially along an axis E-E. A circumferential face 237 of the body 230 may be defined between the first and second faces 234, 232. The faces 234 and 232 may have the same diameter, or they may have different diameters. The circumferential face 237 may have a torsional engagement feature 238 for transmitting torque to a cooperating torsional engagement feature. The torsional engagement feature 238 may be as described in the examples of the torsional engagement feature 226 of the primary mount driving portion 108. The primary mount driving portion 106 may have a mounting aperture 242, couplable to the primary mount 101 and capable of transmitting torque from the primary mount driven portion 106 to the primary mount 101, about the E-E axis. In various examples, the mounting aperture is a circular hole, a recess in the form of a semi-circular arc, or other geometric shapes formed in the body 230 of the primary mount driven portion 106.

FIG. 9D illustrates an example of a secondary mount driven portion 112. The secondary mount driven portion 112 has a body 240. The body 240 may be in the shape of a section of a sloped cylindrical shell with a first face 247, an opposing face 248, and faces 244 and 246 aligned with radii of the sloped cylindrical shell. The body may have a radial face 251including a torsional engagement feature 250 that transmits torque to a cooperating torsional engagement feature. The body 240 of the secondary mount driven portion 112 may have a mounting face 249 located adjacent to the opposing face 248. In one example, the mounting face 249 is an arcuate depression in the body 240 of the secondary mount driven portion 112. The torsional engagement feature 250 may be similar to the torsional engagement feature 226 of the primary mount driving portion 108 and the discussion of specific implementations and gearing types may be the same as described above.

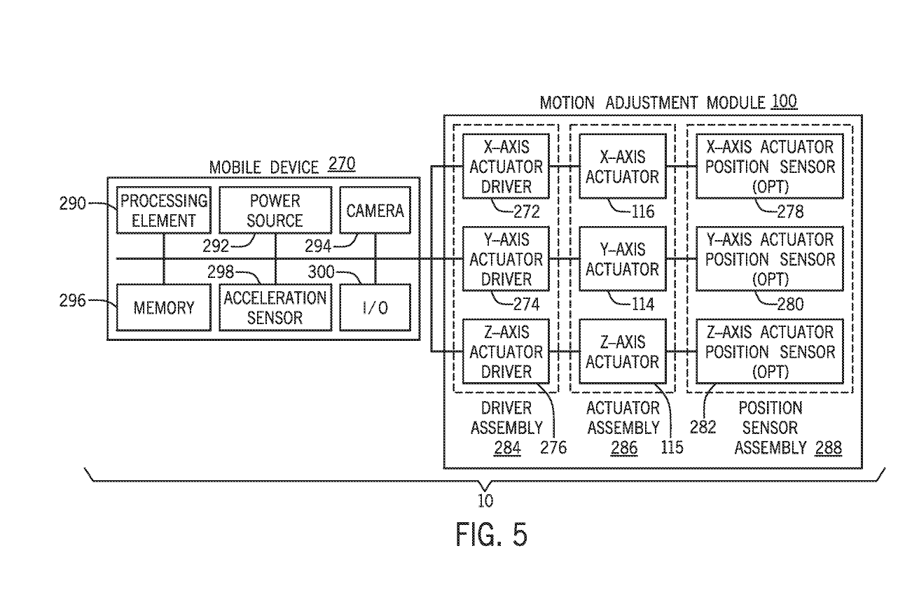

FIG. 5 is a simplified block diagram of internal components of a system 10 for image adjustment or compensation assembly including a user mobile device 270 and a motion adjustment module 100. The user mobile device 270 may include one or more processing elements 290, a power source 292, a camera 294, one or more memory components 296, one or more acceleration sensors 298, one or more input/output (I/O) interfaces 300. Each of the various elements may be in communication, either directly or indirectly, with one another and will be discussed, in turn, below. A simplified block diagram of a motion adjustment module 100 is also shown. The motion adjustment module 100 may include a driver assembly 284, an actuator assembly 286, and optionally a position sensor assembly 288. The elements of the user mobile device 270 may be in communication with one another, and the elements of the motion adjustment module 100. The elements of the motion adjustment module 100 may be in communication with one another. It should be noted that in instances where the motion adjustment module 100 is integrated into the user mobile device 270, certain elements, e.g., processing elements, memory, the like, may be shared across the two components, rather than each module including separate elements.

The processing element 290 is substantially any electronic device capable of processing, receiving, and/or transmitting instructions, including a processor, or the like. For example, the processing element may be a silicon-based microprocessor chip, such as a general purpose processor. In another example, the processing element may be an application-specific silicon-based microprocessor such as a digital signal processor (“DSP”), an application specific integrated circuit (“ASIC”), or an application specific instruction-set processor (“ASIP”). In another example, the processor may be a microcontroller.

The power module 292 supplies power to the various components of the user mobile device 270, and optionally to the components of the motion adjustment module 100. Examples of a power module 292 may include: a primary (one-time use) battery, a secondary (rechargeable) battery, an alternating current to direct current rectifier, direct power connector (e.g., power cord to an external power supply), a photovoltaic device, a thermoelectric generator, a fuel cell, capacitor (either single or double layer), or any combination of the above devices.

The camera 294 may be any device capable of converting incident light into electrical signals. The camera 294 includes one or more sensor elements. In various examples, the sensor element is a charge coupled device, or a complementary metal-oxide semiconductor device, or arrays of the same. The sensor element may have one or more pixels that measure and represent the strength and/or color of light at a particular point on the image sensor. The camera 294 may have one or more optical elements that refract, reflect, focus, or absorb light. In various examples, an optical element is a lens or a mirror. The camera may have a shutter, and it may have a variable aperture that can open or lose to let more or less light into the image sensor, as desired. After converting incident light into electrical signals, the camera 294 may communicate the electrical signals to the memory 296, the processing element 290, or to other elements of the user mobile device 270, or to other devices.

Memory 296 may be any volatile computer readable media device that requires power to maintain its memory state. In one example, memory 296 is random access memory (“RAM”). Other examples may include dynamic RAM, and static RAM. In one example, memory 296 store electronic data used or created by processing element 290. Other examples may include: one or more magnetic hard disk drives, solid state drives, floppy disks, magnetic tapes, optical discs, flash memory, electrically erasable programmable read-only memory, erasable programmable read-only memory, ferromagnetic RAM, holographic memory, printed ferromagnetic memory, or non-volatile main memory.

The acceleration sensor 298 senses acceleration relative to one or more acceleration axes extending in one or more directions. The acceleration sensor 298 outputs a signal corresponding to the motion it senses. In various examples, the acceleration sensor 298 outputs a signal corresponding to acceleration, velocity, speed, direction, position, or displacement. The signal may be received by the processing element 290. In one example, the acceleration sensor 298 is an accelerometer that measures acceleration along three mutually orthogonal acceleration axes. In one example, the three acceleration axes are respectively parallel to the X, Y, and Z axes as shown in FIG. 1B. Alternately, the acceleration axes may not be mutually orthogonal. The acceleration axes may be aligned with major dimensions of the user mobile device 270, the motion adjustment module 100, or both. Alternately, the acceleration axes may not be aligned with major dimensions of the user mobile device 270, nor the motion adjustment module 100. The acceleration sensor 298 may be implemented as a micro-electromechanical accelerometer. Alternately, the acceleration sensor 298 may be a gyroscope. The accelerometer may be direct current (“DC”) coupled, or it may be alternating current (“AC”) coupled. A DC coupled accelerometer may measure static accelerations such as that due to gravity, as well as dynamic accelerations such as those due to movement of the user mobile device 270. An AC coupled accelerometer may measure dynamic accelerations. In various examples, the acceleration sensor 298 is an accelerometer using any of the following technologies: charge mode piezoelectric, voltage mode piezoelectric, capacitive, and/or piezoresistive,

The I/O interface 300 may be any device that provides for input or output that can interface with a user, such as a liquid crystal display; a light emitting diode display; an audio generator such as a speaker; a haptic device that communicates via the sense of touch such as one or more input buttons and/or one or more eccentric rotating mass vibration motors. In one example, the I/O interface 300 includes the display 271, as illustrated in FIG. 1C. In another example, the I/O interface includes a display 271 integrated with a touch screen capable of receiving inputs from the contact of the user's body, or a stylus. Additionally, the I/O interface 300 may provide communication to and from the motion adjustment module 100, and/or a server, as well as other devices. The I/O interface 300 can include a communication interface, such as Wi-Fi™, Ethernet, Bluetooth™, near field communication, radio frequency identification, infrared, or the like, as well as other communication components such as universal serial bus cables or receptacles, or similar physical connections using conductive wires or fiber optic cables.

The driver assembly 284 may include one or more actuator drivers. In one example, the driver assembly 284 includes an x-axis driver 272, a y-axis driver 274, and a z-axis driver 276, which are configured to generate movement along the corresponding axes, such that the drivers may be individualized to generate motion by an actuator along a single axis. The driver assembly 284 may include more or fewer drivers, where the motion along a respective axis may be split or shared by multiple drivers, such that a driver may be responsible for a portion of movement by an actuator along an axis. The actuator drivers 272, 274, 276 convert actuator position, velocity (e.g., speed and direction), and/or actuation commands into electrical signals capable of causing an actuator, e.g., actuators 114, 115, or 116, to move to a desired position, with a desired velocity and/or acceleration.

The actuator assembly 286 may include one or more actuators in electronic communication with one or more drivers. In one example, the actuator assembly 286 includes an x-axis actuator 116, a y-axis actuator 114, and a z-axis actuator 115, e.g., an actuator that defines motion along a particular axis. The actuator assembly 286 may have more or fewer actuators, where, as mentioned above, the motion along an axis is shared between two or more actuators. In various examples, an actuator is a brushed or brushless motor, a servo, a positional rotation servo, a continuous rotation servo, a linear servo, stepper motor, a piezoelectric crystal, a hydraulic or pneumatic piston, or a micro-electromechanical device. It should be noted that the drivers may be integrated into the actuators or otherwise varied to provide commands and control of the motion element.

The position sensor assembly 288, which may be included, includes one or more position sensors that detect the position of the one or more actuators of the actuator assembly, and relay communication regarding the position to the processing element 290, driver, or memory 296 of the user mobile device 270. In one example, the position sensor assembly includes an x-axis actuator position sensor 278, a y-axis actuator position sensor 280, and a z-axis actuator position sensor 282. In this example, there may be a position for the distinct axes, such that a position detector may detect motion along a single axis and provide feedback regarding a particular actuator. However, in other embodiments, the system may include a single position sensor or two position sensors that may cooperate to detect motion along two or more axes. In embodiments including the position sensor assembly, the processing element 290 includes a closed-loop control of the position of the actuators, e.g., actuators 114, 115, 116. One example of closed loop control is a proportional, integral, derivative controller that controls the position, velocity and acceleration of the actuators.

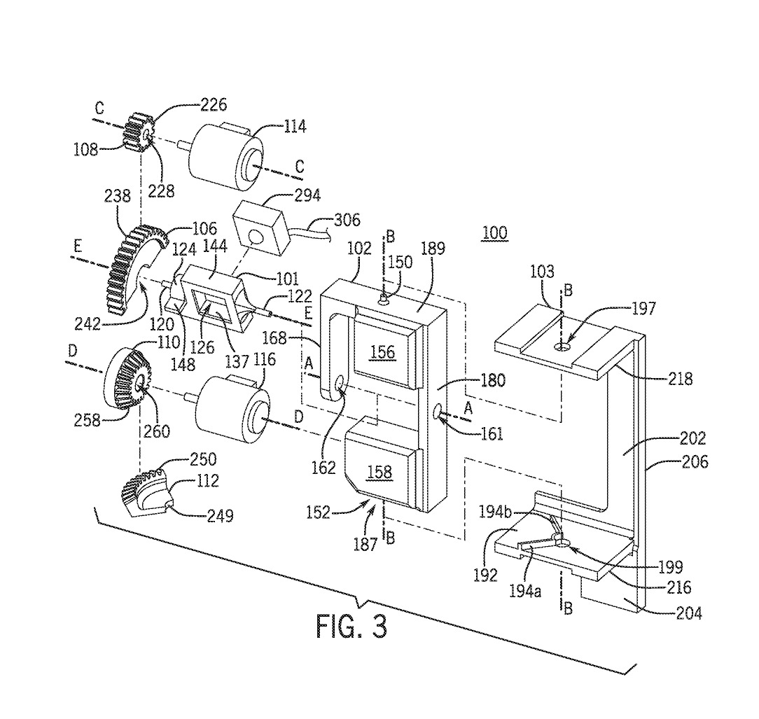

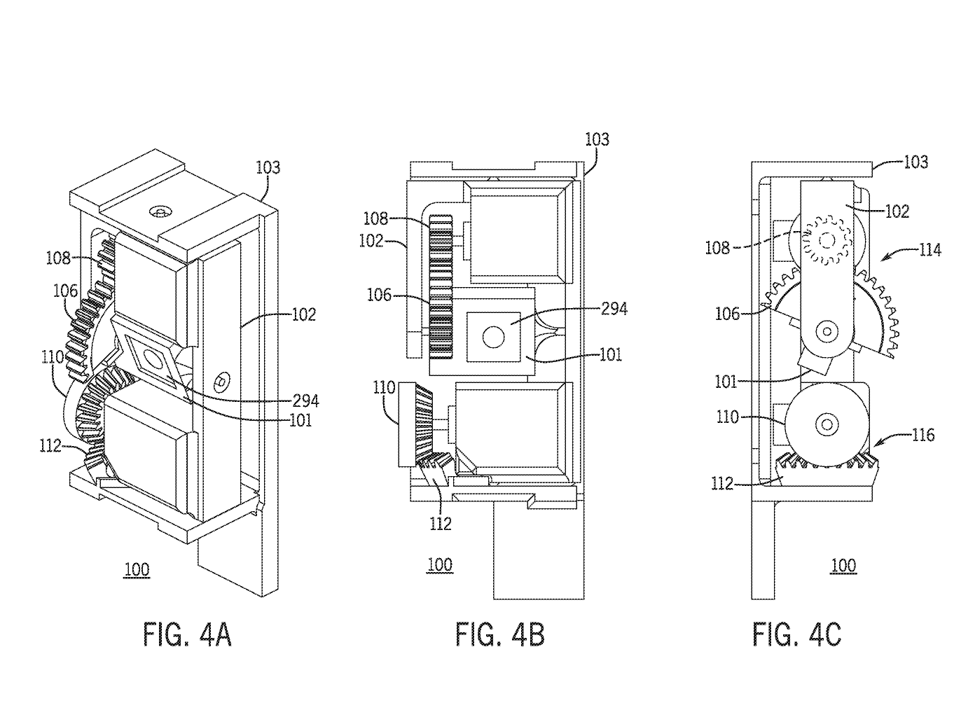

Referring to FIGS. 3, 4A-C, 6A-C, 7A-D, 8A-E, and 9A-D, an example of a method of assembling the motion adjustment module 100 is disclosed. It should be appreciated that other assembly methods, or orders of assembly may be employed without deviating from the present disclosure and the below discussion is meant as illustrative only. The camera 294 is coupled to the primary mount 101, e.g., the camera 294 is inserted into the cavity 136 of the camera receiving feature 137 of the primary mount 101. The camera 294 is oriented so that any lens or optical input of the camera 294 extends through or at least aligns with the aperture 126, such that the field of view of the camera may not be limited or obscured when mounted. The camera 294 may be coupled to the camera receiving feature 136 of the primary mount 101 by a variety of methods, such as adhesives; fasteners such as screws, bolts, rivets, or the like; by press fitting the camera 294 into the receiving feature 136. The camera 294 may be coupled by way of snap-fit features on the camera 294, the mounting flange 138, and/or the walls of the cavity 136, that compress to one position as the camera 294 is partially installed in the receiving feature 136, and spring back to another position as the camera 294 is further installed into the receiving feature 136. As the camera 294 is installed, the communications link 306 may be coupled to the primary mount 101 such that the communications link may allow movement of the primary mount 101 while avoiding damage to the communications link 306.

The driven portion 106 may be coupled to the primary mount 101. In various examples, the driven portion 106 may be coupled to the primary mount 101 with adhesives, fasteners such as screws, rivets or bolts, or snap-fit features. In particular, the driven portion 106 or gear may be seated on the arcuate mounting surface 124 of the primary mount 101. In one example, the driven portion 106 is a semi-circular gear with a flat face 233 cutting through its diameter. The gear couples to the primary mount 101. For example, the flat face 233 aligns with the wings 146 and 148, and the aperture 242 rests on the arcuate surface 124 of the primary mount 101. This coupling of the gear and the primary mount 101 allows the gear to transmit torque to the mount, causing it to pivot.

The actuators 114 and 116 may be coupled to their respective driving portions, 108, and 110. In one example, the driving portions are coupled via an interference press fit of a shaft of the actuator 114 into the shaft receiving aperture 228 of the driving portion 108. For example, an inner diameter of the shaft receiving aperture 228 may be the same size as or smaller than the shaft of the actuator 114, such that the shaft is held within the shaft receiving aperture 228 without allowing relative rotation between the shaft and the driving portion 108. Alternately, the driving portion 108 may be coupled to the actuator 114 shaft by way of keys and keyways, or other fasteners such as screws or bolts. Similar methods may be employed for coupling the driving portion 110 to the actuator 116.

The actuators 114 and/or 116 may then be installed within the respective actuator receiving feature 178 and 176, in order to couple the actuators to the secondary mount 102. For example, the actuators may be received within the pockets or receiving features to be substantially enclosed. In one example, the actuator receiving feature 178 and 176 hold the respective actuators 114 and/or 116 to prevent relative rotation between the actuators 114, 116 and the respective receiving feature 178, 176. For example, the apertures may resist a rotation of the actuators 114, 116 when a driving torque is applied by the actuators 114, 116 to the respective driving portions 108, 110. In various examples, the shafts of the actuators 114 and 116 may be arranged parallel to one another, or antiparallel to one another.

The primary mount 101 may then be installed within the secondary mount 102. In one example, one of the first pivot shaft 120 or the second pivot shaft 122 of the primary mount 101 are inserted within one of the first or second primary mount pivot apertures 161, 163. The other of the first pivot shaft 120 or the second pivot shaft 122 of the primary mount 101 may be inserted within the other of the first or second primary mount pivot apertures 161, 163. The secondary mount 102 and/or the primary mount 101 may deform or flex elastically, without breaking or deforming plastically, to facilitate this assembly operation. The assembly of the primary mount 101 and the secondary mount 102 allows the primary mount 101 to pivot within the secondary mount 102 about the axis A-A. When installing the primary mount 101, the torsional engagement feature 226 of the primary mount driving portion 108 and the torsional engagement feature of the primary mount driven portion 106 are engaged with one another, to facilitate the transfer of torque and/or rotation from the driving portion 108 to the driven portion 106. In one example, where the respective torsional engagement features 226, 238 are gear teeth, the teeth of the primary mount driving portion 108 are aligned with the gaps between the gear teeth of the primary mount driven portion 106, such that the two driving and driven portions are engaged with one another. For example, the gear teeth of the driving portion 108 may mesh with the gear teeth of the driven portion 106. The gear teeth may have an involute profile, such that two mating teeth form an instantaneous point or line of contact that moves on a common tangent between the driven and driving portions as they rotate. Teeth that mate in this manner may allow the rotational speed of the driven portion to remain substantially constant for a given speed of the driving portion, thereby allowing for a smooth transfer of motion from the driving portion to the driven portion. In another example, the torsional engagement features 226, 238 are aligned with one another axially along axes parallel to the axis A-A. In another example, if the torsional engagement features 226, 228 are pulleys, they may have a power transfer element arrayed between them. In one example, the power transfer element is a belt, 0-ring, band, cable, or the like.

The secondary mount driven portion 112 may be coupled to the tertiary mount. The secondary mount driven portion 112 may couple to a secondary mount driven portion support bracket 192. In one example, the faces 244, 246 and mounting face 249 of the secondary mount driven portion 112 cooperate with the arms 194a and 194b to couple the secondary mount driven portion 112 to the tertiary mount 103. In one example, the driven portion 112 is an arcuate geared rack with the faces 244, 246 forming an angle. The arms 194a , 194b may define a corresponding angle, allowing the gear 112 to snap or clip into place between the arms 194a, 194b, supported by the support bracket 192. Alternately, the gear 112 may be glued, ultrasonically welded, or otherwise adhered to the arms and/or to the support bracket.

The secondary mount 102, with the assembled primary mount 101, may then be installed within the tertiary mount 103. In one example, one of the first pivot shaft 150 or the second pivot shaft 152 of the secondary mount 102 may be inserted within one of the first or second secondary mount pivot apertures 199, 197. The other of the first pivot shaft 150 or the second pivot shaft 152 of the secondary mount 102 may be inserted within the other of the first or second secondary mount pivot apertures 199, 197. The secondary mount 102 and/or the tertiary mount 103 may deform or flex elastically, without breaking or deforming plastically, to facilitate this assembly operation. The assembly of the tertiary mount 103 and the secondary mount 102 allows the secondary mount 102 to pivot within the tertiary mount 103 about the axis B-B.

During the assembly of the components of the motion adjustment module 100, various cables, wires, or circuit boards of the communications link 306 may be routed, fastened, or secured to the various components of the motion adjustment module 100 to allow for movement of the primary mount 101, and/or the secondary mount 102 without damage to the mounts 101, 102, 103, or the communications link 306.

At various stages of the assembly process, assembly aids such as oils, greases, dielectrics or other compounds may be applied to the driving portions 108, 110; the driven portions 106, 112; the shafts 120, 122, 150, 152; the bearing surfaces 160, 162, 198, 200; and/or electrical connectors of the communications link 306.

A housing or enclosure may be fitted to the motion adjustment module 100 to prevent the ingress of contaminants, such as dirt, dust, water, other liquids, or other matter which may interfere with the operation of the motion adjustment module 100.

### Operation of the Motion Adjustment Module

The operation of the motion adjustment module 100 may include the processing element 290 sending position commands to the actuators, via the actuator drivers, commanding the actuators to move to certain positions. In one example, the processing element 290 sends a move command via the communications link 306 to the actuator 114. The move command may be a command to move to a certain position, move a certain rotation, or move a particular increment. The move command may also include information on the speed and/or direction the actuator 114 is to move. The command may be a pulse-width modulated voltage and/or current waveform. The move command may be an analog direct current or voltage signal scaled between two endpoints. For example, the move command may be a voltage of 5 V, and the actuator 114 may scale its rotational position between endpoints such as 0-10V. In this example, the actuator may move to one half of its rotational range. Alternately, the move command may be a current signal. For example, the signal may be 12 mA, scaled between 4-20 mA. In this example, the actuator may also move to one half of its rotational range.

When an actuator moves, an output shaft on the actuator may rotate, causing a coupled driving portion to rotate. For example, the output shaft of actuator 114 may rotate and its connection to the primary mount driving portion 108 causes the primary mount driving portion 108 to rotate a corresponding amount. The torsional engagement feature 226 of the driving portion 108 cooperates with a torsional engagement feature on a driven portion to transmit the motion. For example, the torsional engagement feature 226 of driving portion 108 may cooperate with the torsional engagement feature 238 of the primary mount driven portion 106, transmitting torque from the driving portion 108 to the driven portion 106. The driven portion 106 may then transmit torque to the primary mount. Torque and motion are transmitted from an actuator, through a driving portion, to a driven portion and then to a mount, causing the mount to move. Other actuators, driving portions, driven portions, and mounts disclosed operate similarly.

Alternately, the output shaft of a first actuator may rotate about a first axis, causing the actuator and mount holding the first actuator to rotate about a second axis. The rotation of the first actuator shaft about the first axis may also cause a second actuator to rotate about the second axis. In one example, the driving portion 110 is a gear and its torsional engagement feature 238 is a plurality of gear teeth. The gear teeth of the driving portion 110 are mated with corresponding torsional engagement feature 250, or gear teeth, on the driven portion 112, which in this example is an arcuate geared rack. The actuator 116 rotates the gear 110 about the axis D-D, causing the gear to move along the rack. The rack generates a force on the gear 110 causing the actuator 116, and the secondary mount 102, to pivot about the axis B-B, relative to the tertiary mount 103. The actuator 114, and primary mount 101 which are also mounted to the secondary mount 102 likewise pivot about the axis B-B. The independent motions of the actuators 116 and 114 thus combine to allow for tilt and pan operation of the camera.

The primary mount actuator 114 and the secondary mount actuator move independently of one another, allowing the camera to pan and tilt relative to the x-axis and y-axis, with movement along one axis being separate from movement along the other axis. In some embodiments, additional actuators can be included that allow the camera to rotate relative to the z-axis, separate from the y or x axes. The processing element 290 may record actuator positions in the memory 296 based on a series of commands relative to an initial starting position. Alternately, position sensors may record actuator positions and send them to the processing element 290. The processing element 290 may cause the actuators to rotate the camera 294 to adjust for motion of the camera, the user mobile device 270, the user 302, or one or more subjects 304.

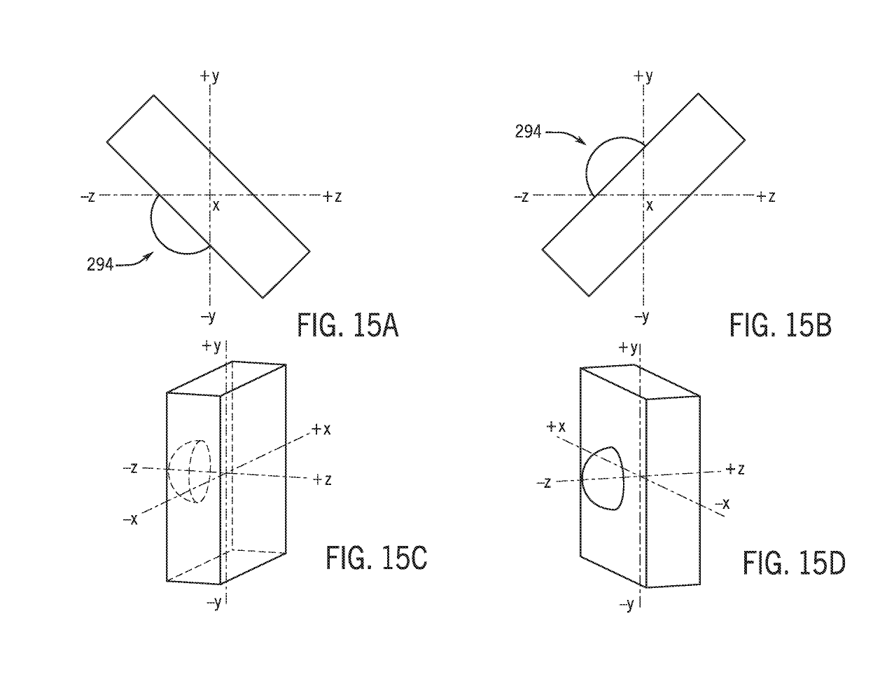

FIGS. 15A-15D illustrate partial schematic views of rotation of the camera 294 relative to various axes. FIG. 15A shows the camera rotated counter clockwise about the x-axis relative to the y-axis and x-axis (the x-axis is normal to the plane of the figure). FIG. 15B shows the camera 294 rotated clockwise about the x-axis relative to the y-axis and z-axis. Similarly, FIGS. 15C and 15D show the camera 294 rotated about the y-axis relative to the x-axis and z-axis.

### Motion Compensation Utilizing the Motion Adjustment Module

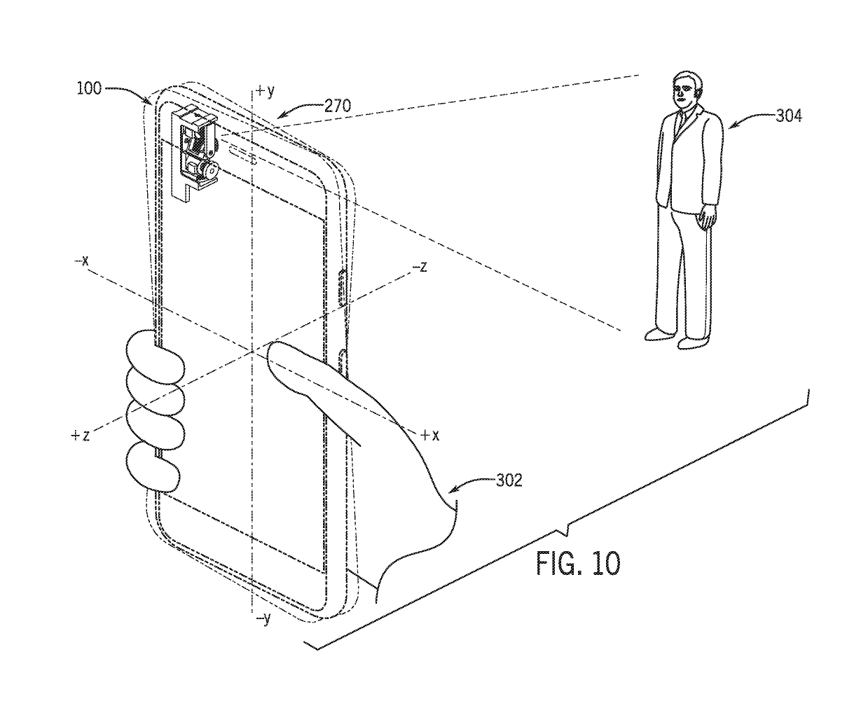

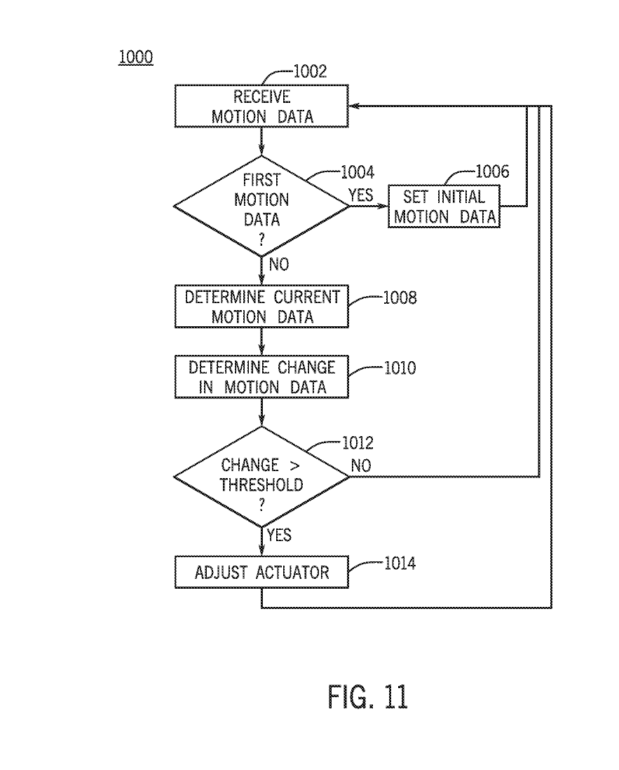

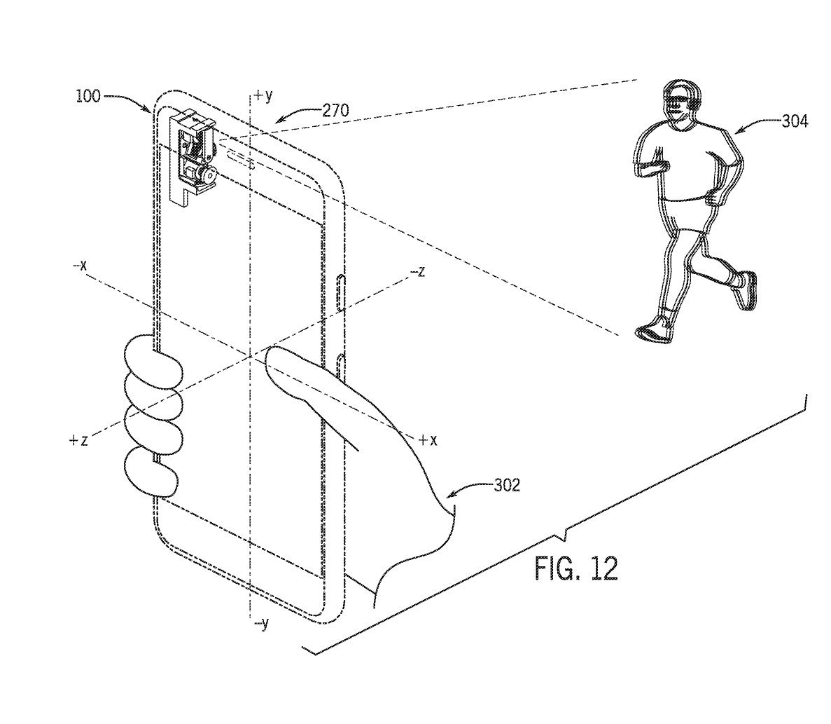

FIG. 10 illustrates a partial schematic view of a user 302 using a user mobile device 270 to capture an image, or images of a subject 304. FIG. 10 illustrates a common problem encountered by users when trying to capture an image while hand-holding a user mobile device 270; the user 302 is unable to hold his hand steady, possibly resulting in image blur. The methods, devices and systems disclosed help reduce blur caused by camera motion by measuring motion of the user mobile device 270 and moving the camera a corresponding offset amount in an direction opposite from the motion. A user 302 then is freed from concentrating on the remaining still, and can concentrate instead on the subject of the images or video they wish to capture. FIG. 11 is a flow chart of a method 1000 utilizing the motion adjustment module 100 to reduce or eliminate blur induced by motion of the user 302 or motion of the mobile device 270 during image capture. The method may be executed by the processing element 290 in the user mobile device 270, or a similar processing element within the motion adjustment module 100, or a combination of the two and/or other processing elements. The operations of this method and other methods of the disclosure may be performed for different axes, and/or in different directions of axes of the user mobile device 270, simultaneously and independently from one another. For example, the processing element 290 may implement one instance of the method 1000 for the x-axis, an independent instance of the method 1000 for the y-axis, and another independent instance of the method for the z-axis. Alternately, one instance of the method may be performed on all axes of the user mobile device 270. In another example, portions of the method, and portions of individual operations of the method may be performed in whole or in part on all, or portions of the motion data. The operations of the method 1000 may be performed in different orders than those presented without deviating from the present disclosure. The method may be repeated at different speeds, suitable for the images being captured. In one example, the method repeats at 50-Hz. The method may operate at higher or lower speed as desired, and may be adjusted dynamically by the processing element 290, or the user 302.

With reference to FIG. 11, the method may begin in operation 1002 and a processing element 290 receives motion data about the user mobile device 270. For example, the processing element 290 receives motion data from the one or more acceleration sensors 298 via the communications link 306. In one example, the one or more acceleration sensors 298 detect acceleration of the user mobile device 270. The processing element 290 may additionally determine velocity and/or position data. Alternately, velocity and/or position data may be determined by an acceleration sensor 298 directly. In one example, the processing element 290 integrates acceleration over time to determine velocity data of the user mobile device 270. In one example, the processing element 290 further integrates velocity data over time to determine position data of the user mobile device 270. The processing element 290 and/or the acceleration sensor 298 may determine changes to acceleration, velocity, and position. The motion data may include data about motion relative to one or more axes, for example, the x-axis, y-axis, and/or z-axis. The motion data may include data about linear motion of the user mobile device 270 relative to the one or more axes. For example, the motion data may include acceleration data, velocity data, and/or position data in directions parallel or antiparallel to one or more of the axes. The motion data may include data about rotational motion of the user mobile device 270 relative to the one or more axes. For example, the motion data may include rotational acceleration, velocity, and/or position about one or more of the axes.

With receipt of the motion data, the method may proceed to operation 1004 and the processing element 290 determines if the motion data received is a first motion or initial motion data. The initial motion data may be determined relative to a start of the method, as a way of zeroing out or creating a reference for subsequent motion measurements. In one example, the user 304 of the user mobile device 270 pushes a button (either a physical button, or a soft button on a touchscreen) initiating the method 1004 in the processing element 290. The processing element 290 determines the initial motion data relative to the time the user pushed the button. Alternately, in another example, the user could speak a command to the user mobile device 270 to start the method and capture the initial motion data. Capturing initial motion data is analogous to setting the tare value of a weigh scale. If the motion data is a first motion data, the method may proceed to operation 1006. If the motion data is not a first motion data, the method may proceed to operation 1008.

In operation 1006, when the processing element 290 has determined that the motion data is a first motion data, the processing element 290 records the motion data, for example in memory 296 as an initial motion data, which may be used to determine the initial positions of the camera and/or mobile device at the beginning of image capture. In various examples, the motion data is vector of one or more linear or rotational accelerations, velocities, and/or positions relative to the one or more axes. The method then may return to operation 1002.

If in operation 1004, the motion data is not initial or first motion data, the method may proceed to operation 1008 and the processing element 290 determines the current motion data of the user mobile device 270 from the motion data. In various examples, the current motion data is a vector of one or more linear or rotational accelerations, velocities, and/or positions relative to the one or more axes. In one example, the current motion data represents shaking or movement of the user mobile device 270 in the user's 302 hand subsequent to the start of the method. Even if a user 302 tries very hard to hold still, slight movements may exist, caused by breathing, the user's heartbeat, or environmental factors, such as wind. Alternately, the user mobile device 270 may move if the user 302 is filming from a running or moving car, bike, or other vehicle. In another example, the user may be running, walking, skiing, swimming, or otherwise in motion. In these examples, the current motion data may be accelerations induced into the user mobile device 270 by the user directly or indirectly. The current motion data may also be velocities and/or positions determined by the processing element 290 by integration of acceleration signals over time.

The method may proceed to operation 1010 and the processing element 290 determines a change in motion data relative to the initial motion data recorded in operation 1006. For example, the processing element 290 may subtract an acceleration, velocity, and/or position value of the current motion data from the initial motion data with respect to one or more axes, to determine a change in linear or rotational acceleration, velocity and/or position.

The method may proceed to operation 1012 and the processing element 290 compares the change in motion data to one or more thresholds. If the change in motion data is greater than a threshold, the method may proceed to operation 1014. If the change is equal to or below a threshold, the method may return to operation 1002. There may be different thresholds for different motion data, for example, different thresholds for acceleration, velocity, and position or distance changes, respectively. There may also be different thresholds for different axes, for example, the x-axis, y-axis, and z-axis, respectively. There may also be different thresholds for rotational and linear changes to motion data.

In one example, the processing element 290 may determine that the user mobile device 270 has rotated 3 degrees about the x-axis, in a direction such that the camera 294, is tilted in the −z direction, and the end of the user mobile device 270 opposite the camera has rotated in the +z direction. Continuing the example, the processing element 290 may determine that the user mobile device 270 has rotated 6 degrees about the y-axis, with the user's 302 right side of the user mobile device 270 moving in the +z direction and the user's 302 left side of the camera moving in the −z direction. If the x-axis rotation threshold is +/−5 degrees, and the y-axis rotation threshold is +/−4 degrees, operation 1012 would determine that the method should proceed to operation 1014 with respect to the y-axis, and operation 1002 with respect to the x-axis.

In instances where the change exceeds the defined threshold, the method may proceed to operation 1014 and the processing element 290 adjusts an actuator to counteract the change in motion data determined in operation 1010. Continuing the example above with respect to the y-axis, the change in motion data for the y-axis of 6 degrees is above the threshold of 4 degrees. Therefore, in operation 1014, the processing element 290 will send a command to the y-axis actuator driver 274 to rotate the y-axis actuator 6 degrees in a direction opposite the change in y-axis motion data. In this example, the processing element 290 will command the actuator to rotate about the y-axis with the user's 302 right side of the user mobile device 270 moving in the −z direction and the user's 302 left side of the camera moving in the +z direction, 6 degrees, thereby counteracting the motion of the user mobile device 270. The motions of the actuators 114 and/or 116 cause the driving portions 108 and/or 110 to rotate, which rotate the driven portions 106 and/or 112. The rotation of the driven portions causes one or more of the mounts 101 and/or 102 to pivot about their pivot axes, ultimately pivoting the camera to an adjustment position, offsetting the motion of the user mobile device 270.

Using method 1000 with a motion adjustment module 100 allows a user 302 to capture video or images with less worry about remaining still, because the actuators compensate for the user's motion. The result may be higher quality images or video. The user 302 may also capture images or video more spontaneously without the need to brace for stability, stop running, park their car, or otherwise interfere with their activities. The user 302 can then concentrate on the moment and the images or video they want to capture, rather than concentrating on holding still.

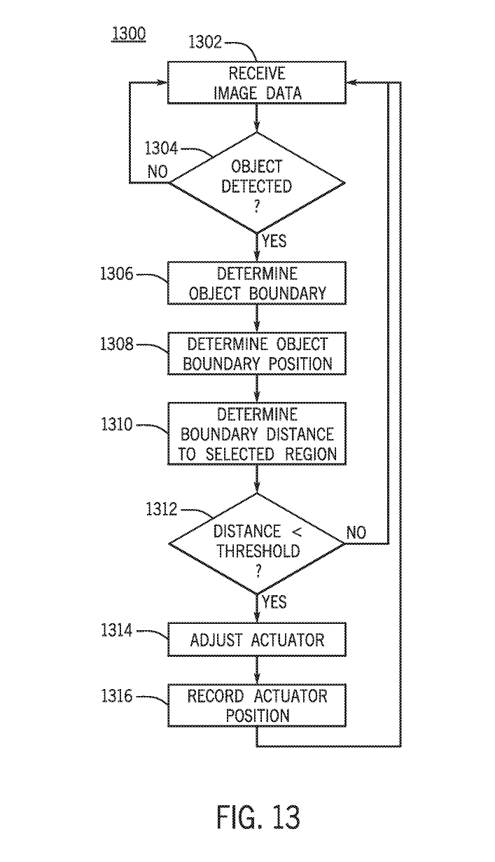

FIG. 12 illustrates a partial schematic view of a user 302 using a user mobile device 270 to capture an image, or images of a moving subject 304. FIG. 12 illustrates a common problem encountered by users when trying to capture an image of a moving subject; the motion of the subject results in image blur. FIG. 13 discloses an example of a method 1300 of operating the motion adjustment module 100 as shown in FIG. 12, to reduce or eliminate blur induced by motion of the subject 304. The operations of this method and other methods of the disclosure may be performed for different axes, and/or in different directions of axes of the user mobile device 270, simultaneously and independently from one another. For example, the processing element 290 may implement one instance of the method 1300 for the x-axis, an independent instance of the method 1300 for the y-axis, and another independent instance of the method for the z-axis. Alternately, one instance of the method may be performed on all axes of the user mobile device 270. In other examples, portions of the method, and portions of individual operations of the method may be performed in whole or in part on all, or portions of the image data. The operations of the method 1300 may be performed in different orders than those presented without deviating from the present disclosure. The method 1300 may be repeated at different speeds, suitable for the images being captured. In one example, the method repeats at 50-Hz. The method 1300 may operate at higher or lower speeds as desired, and may be adjusted dynamically by the processing element 290.

The method may begin in operation 1302 and the processing element 290 receives image data from the camera 294 via the communications link 306. The image data may be a still image, such a picture; a series of pictures, or a series of frames such as video frames. The processing element 290 may store images in memory 296 to execute the method on later, or it may execute the method on the image data as it is received. The processing element 290 may execute the method on part, or substantially all of the image data. For example, the processing element 290 may discard certain frames of a video stream, and perform the method on others.

The method may proceed to operation 1304 and the processing element 290 detects an object. The processing element 290 may have been trained to detect certain classes or patterns of objects or otherwise may rely on object detection databases or the like to determine if an image includes a selected object, such as a subject. In one example, the processing element 290 may have been trained through machine learning algorithms. In various examples, the processing element 290 may be trained to detect human faces; pets; vehicles such as cars, airplanes, boats or the like; celestial bodies, such as the sun, moon, planets stars or the like; or other objects of interest. The processing element 290 scans the pixels of the image data to determine if a focus object is present within the image, e.g., an object that should be the centered focus of a frame or otherwise “locked on” by the camera module. If the processing element 290 detects an object, the method may proceed to operation 1306. If an object is not detected, the method may return to operation 1302.

The method may proceed to operation 1306 and the processing element 290 determines a boundary around the object. In one example, the boundary may be a bounding box or area circumscribed around the extents of the object. In another example, the boundary may correspond substantially with contours or extents of the object, e.g., defined by the perimeter of the object. The processing element 290 may adjust the object boundary as the object becomes larger or smaller in the image frame, for example as a result of the object approaching or receding from the camera 294, or from zoom effects caused by either optical or digital zoom.

The method may proceed to operation 1308 and the processing element 290 determines a position of the object boundary. The processing element 290 may determine a position of the object boundary within the image frame, for example, relative to one or more edges of an image frame of the image data. In various examples, the processing element 290 determines a distance from a top of the image boundary relative to a top edge of a frame of the image data; a distance from the left side of the image boundary to the left edge of the frame; a distance from the right side of the image boundary to the right edge of the image frame; and/or a distance from the bottom of the image boundary to the bottom of the frame.

The method may proceed to operation 1310 and the processing element 290 determines a distance from the object boundary to a selected region. The distance may be determined by pixels, physical measurements, or the like. In various examples, the selected region is one or more of the top, left, right or bottom edges of the image frame. For example, the processing element 290 may determine that the bottom edge of the object boundary is 50 pixels from the bottom of the image frame. However, it should be noted that other boundary thresholds may be used depending on the desired object lock by the user, size of the object, resolution of the image, etc. The selected region may define a buffer around one or more of the edges and/or may be defined by another object within the frame. The processing element 290 may also determine a velocity vector, or a direction and rate of change of the distance between the object boundary and the selected region, in order to determine how quickly the object boundary may reach the selected region. For example, the processing element 290 may determine that the bottom of the object boundary is approaching the bottom of the image frame at the rate of 10 pixels per second, and the left edge of the object boundary is approaching the left edge of the image frame at 5 pixels per second.

The method may proceed to operation 1312, and the processing element 290 determines whether the distance between the object boundary and the selected region is less than a threshold. The processing element 290 may also predict whether the distance between the object boundary and the selected region may be less than a threshold in the future, based on the velocity of the object. If the distance between the object boundary and the selected region is less than or equal to the threshold, the method may proceed to operation 1314, where an actuator is adjusted. In one example, a selected object could be a skier coming down a run. As the skier moves back and forth across the ski run, she will move relative to the edges of the image frame. A threshold relative to the left and right edges of the frame could be 100 pixels, for example. If the boundary around the skier moves to less than 100 pixels from an edge of the frame, the method would proceed to operation 1314 and adjust an actuator, and thus the camera 294, to keep the skier 100 pixels or more from the edge of the frame. If the distance between the object boundary and the selected region is greater than the threshold, the method may return to operation 1302.

The method may proceed to operation 1314 and the processing element 290 adjusts an actuator to counteract the motion of the object boundary relative to the selected region. In one example, the object is a runner, the selected region is the right edge of the image frame, and the threshold is 100 pixels. If the boundary around the runner is less than 100 pixels from the right edge of the image frame, the processing element 290 may command an actuator via an actuator driver, such driver 272 and secondary mount actuator 116, to rotate the camera 294 an amount sufficient to move the boundary around the runner to the left, relative to the right edge of the image frame, thus keeping the edge of the runner's boundary 100 pixels or more from the right edge of the image frame. The amount of actuator rotation for example around the axis C-C or D-D, and thus the amount of camera pan or tilt, may be varied based on the amount of the distance between the object boundary and the selected region, and/or the velocity of the object relative to the region. For example, if the distance between the object boundary and the region is small, the adjustment of the actuator may be large. Additionally, if the velocity of the object is large, adjustments to the actuator may be large to compensate for the quickly changing object motion.

The method may proceed to operation 1316 and the processing element 290 records the position of the actuator after adjustment. The processing element 290 may record the position of the actuator based on a difference between its initial position and the amount it was commanded to move. Alternately, the actuator may have a position sensor that sends actuator position data to the processing element 290. The actuator position data may be stored in memory 296.

Using method 1300 with a motion adjustment module 100 allows a user 302 to capture video or images with less worry about capturing moving subjects 304, because the actuators compensate for the subject's 304 motion, resulting in better images or video and allow the object to remain within the frame, instead of bouncing around within the frame or out of the frame due to motion of the object or the user capturing the images. The user 302 may also capture images or video more spontaneously without asking the subjects 304 to hold still. In the case of active subjects, such as skiers, toddlers, runners, or other moving subjects, having the subject hold still may defeat the purpose of capturing the image in the first place. For example, if the subject is a horse and rider jumping over a rail, it is not possible to capture such an image with the horse and rider holding still. Using the method 1300 and a motion adjustment module 100 however, can compensate for the motion of the subject and capture the image or video while reducing blur. The method 1300 may also be used for instance to keep a reference region in an image in a steady spot relative to the image frame. In various examples, the reference region is a road, trail, shoreline, building, cliff, or the horizon.

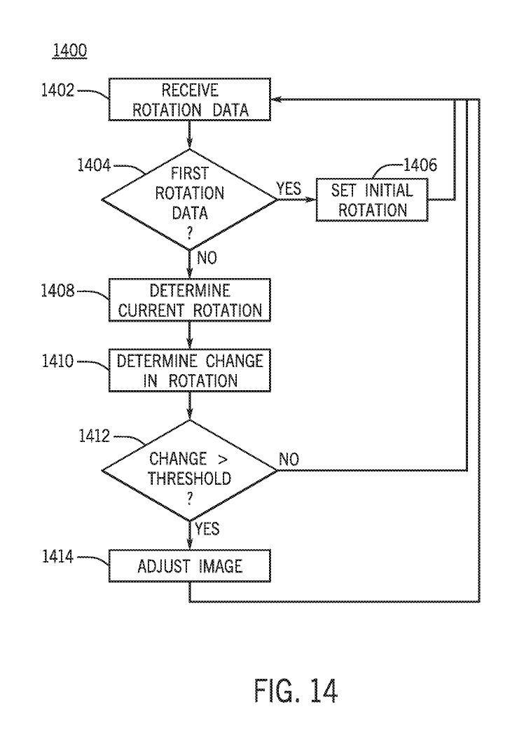

FIG. 14 illustrates an example of a method 1400 of adjusting the rotation of image data of a user mobile device 270. The method 1400 may be used for instance to keep an image right side up, even as the actuators employed by other methods of using the motion adjustment module 100 cause the camera to rotate upside down or sidewise relative to a starting position. As with other methods disclosed, the speed at which the method operates may be adjusted based on the images being captures, and may be dynamically adjusted by the processing element 290, or the user 302.

The method may begin in operation 1402 and the processing element 290 receives rotational data from an acceleration sensor 298 of the user mobile device 270. The rotation data may include data about rotational motion of the user mobile device 270 relative to one or more axes, e.g., the x-axis, y-axis, or z-axis. Preferably, the rotation data is relative to an axis normal to the image sensor of the camera 294, e.g., the z-axis.

The method may proceed to operation 1404 and the processing element 290 determines if the rotation data received is a first rotation data. If the rotation data is a first rotation data, the method may proceed to operation 1406. If the rotation data is not a first rotation data, the method may proceed to operation 1408.

In operation 1006, the processing element 290 may have determined that the rotation data is a first rotation data. The processing element 290 then records the rotation data, for example in memory 296. In various examples, the rotation data is vector of one or more rotational accelerations, velocities, and/or positions relative to the one or more axes. The method then may return to operation 1402.

From operation 1404, the method may proceed to operation 1408, if the rotation data is not the first rotation data. In operation 1408, the processing element 290 determines the current rotation data of the user mobile device 270 from the rotation data. In various examples, the current rotation data is a vector of one or more rotational accelerations, velocities, and/or positions relative to the one or more axes.

The method may proceed to operation 1410, and the processing element 290 determines a change in rotation data relative to the initial rotation data recorded in operation 1406. For example, the processing element 290 may subtract an acceleration, velocity, and/or position value of the current rotation data from the initial rotation data with respect to one or more axes, to determine a change in rotational acceleration, velocity and/or position.

The method may proceed to operation 1412 and the processing element 290 compares the change in rotation data to one or more thresholds. If the change in rotation data is greater than a threshold, the method may proceed to operation 1414. If the change is equal to or below a threshold, the method may return to operation 1402. There may be different thresholds for different rotation data, for example, different thresholds for acceleration, velocity and position changes, respectively. There may also be different thresholds for different axes, for example, the x-axis, y-axis, and z-axis, respectively. In one example, the processing element 290 may determine that the user mobile device 270 has rotated 5 degrees about the z-axis, in a clockwise direction relative to the user 302. If the z-axis rotation threshold is +/−2 degrees, operation 1412 would determine that the method should proceed to operation 1414 with respect to the z-axis. If the threshold were +/−10 degrees, the method may return to operation 1402.

The method may proceed to operation 1414, and the processing element 290 adjusts an actuator, or a digital rotation of an image, to counteract the change in rotation data determined in operation 1410, if that change is above a threshold. Continuing the example above for operation 1412 with respect to the z-axis, the change in rotation data for the z-axis of 5 degrees is above the threshold of +/−2 degrees. Therefore, in operation 1414, the processing element 290 may send a command to a z-axis actuator driver 274 to rotate a z-axis actuator 5 degrees in a direction opposite the change in z-axis motion data, e.g., counterclockwise with respect to the user 302. Alternately, the processing element 290 may digitally rotate the image data 5 degrees counter clockwise with respect to the user 302. The processing element 290 may adjust the actuator position and/or digital rotation of the image data more, or less depending on the amount of rotational displacement, the speed of rotational displacement, or both.

Any of the disclosed methods may be performed simultaneously, serially, or in parallel during the capture of an image or video. For example, the processing element 290 may perform method 1000 to correct for movement of the camera 294, while also performing method 1300 to track and keep an object in the image frame, while also performing method 1400 to adjust the rotation of the captured images or video. In one example, of using these methods together, one runner with a user mobile device 270 may take video of another runner. In the example, the motion adjustment module 100 adjusts for the motion of runner holding the user mobile device 270, while also adjusting for the motion of the subject runner relative to the image frame. The various operations, and parts of the various operations of the methods may be performed on different processing elements. For example, portions of one method may be performed in a processing element 290 within the user mobile device 270, while other operations of the same method or different methods may be performed on a processing element 290 within the motion adjustment module 100.

### Additional Embodiments

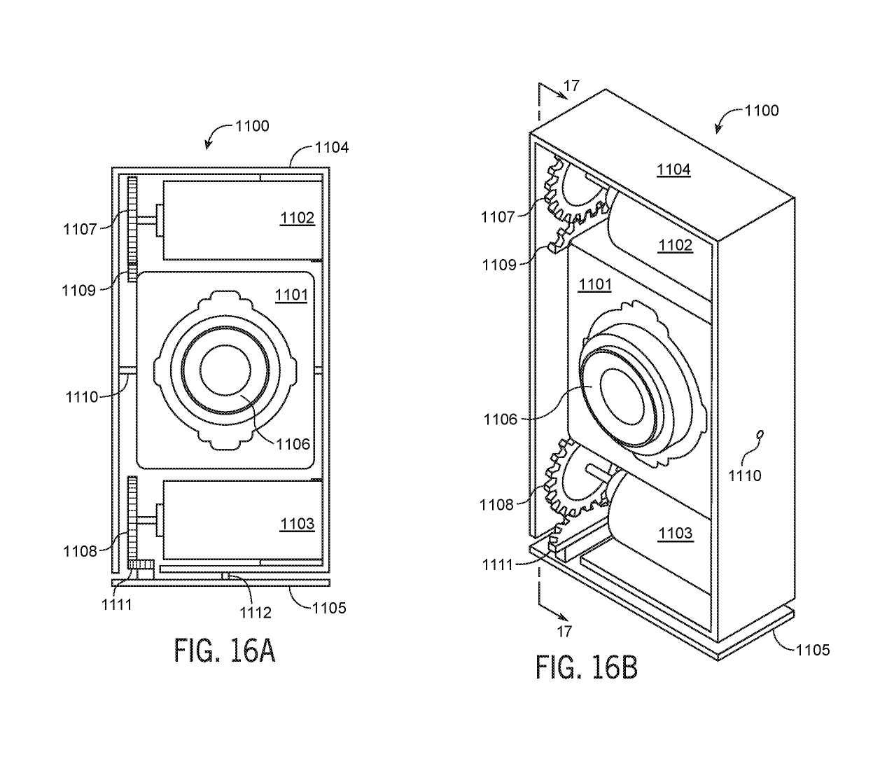

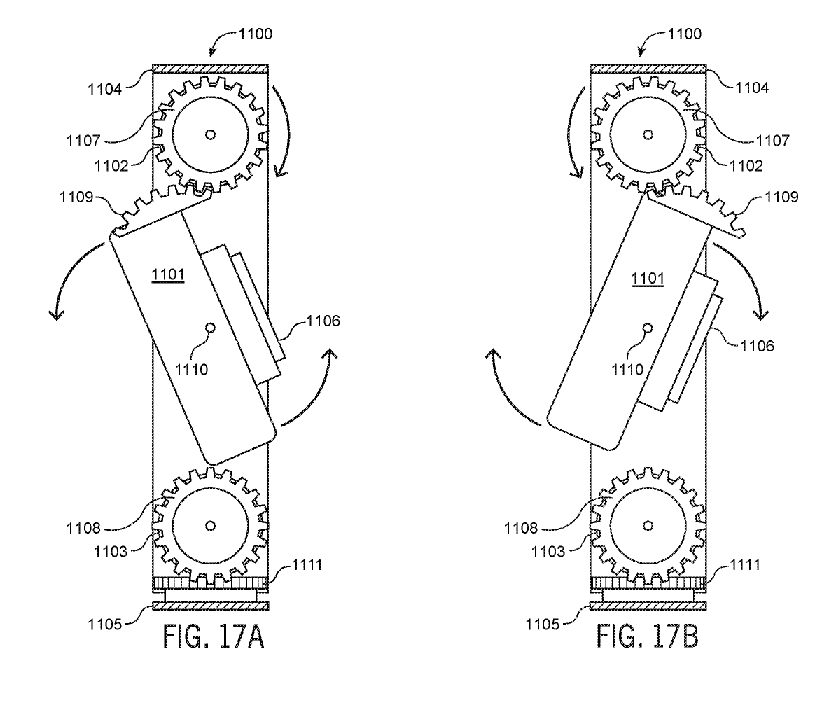

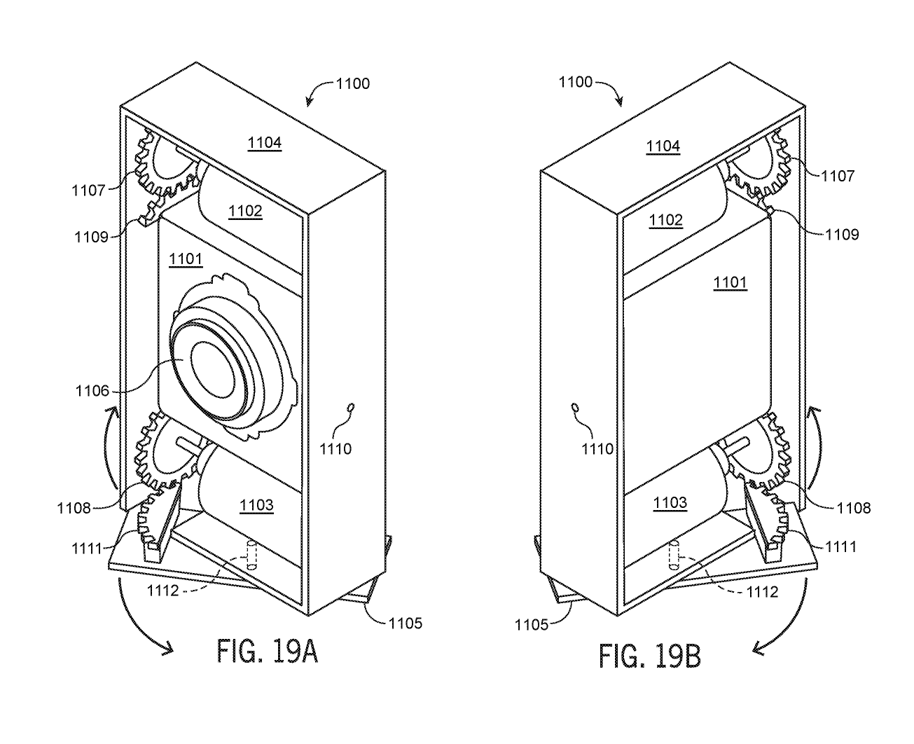

FIGS. 16A-21 illustrate another example of a motion adjustment module 1100. As illustrated in FIGS. 16A, 16B, 19A, and 19B, the motion adjustment module 1100 may include three separate mounts. In one example, the tertiary camera mount 1105, which may be anchored to the body of the a user mobile device 270 (not shown), may hold the secondary camera mount 1104 upon the secondary vertical axis 1112. The secondary camera mount 1104 may hold the tilt actuator 1102 and the pan actuator 1103. The secondary camera mount 104 may hold the primary camera mount 1101 upon the primary horizontal axis 1110. The primary camera mount 1101 may hold the user mobile device 270 camera component 1106.

FIGS. 16A illustrates an example of the motion adjustment module 1100 where the tilt actuator gear 1107 is fixed to the shaft of the tilt actuator 1102, and the pan actuator gear 1108 is fixed to the shaft of the pan actuator 1103. Therefore, a rotation of the tilt actuator gear 1107 may be caused by rotation initiated by the tilt actuator 1102. Likewise, a rotation of the pan actuator gear 1108 may be caused by rotation initiated by the pan actuator 1103.

FIGS. 17A and 17B illustrate, with the aid of the directional arrows in the figures, the tilting motion of the example of the motion adjustment module 1100. The vertical contact edge 1109 may include a portion of a circular gear whose radius may originate from the primary horizontal axis 1110. The vertical contact edge 1109 may be fixed to the primary camera mount 1101 in a suitable way such that the tilt actuator gear 1107 may be in contact with the vertical contact edge 1109. This configuration may allow the primary camera mount 1101 to tilt upward and/or downward upon the primary horizontal axis 1110 through a rotation force generated by the tilt actuator 1102. This rotation preferably would not exceed a magnitude that would result in loss of contact between the vertical contact edge 1109 and the tilt actuator gear 1107.

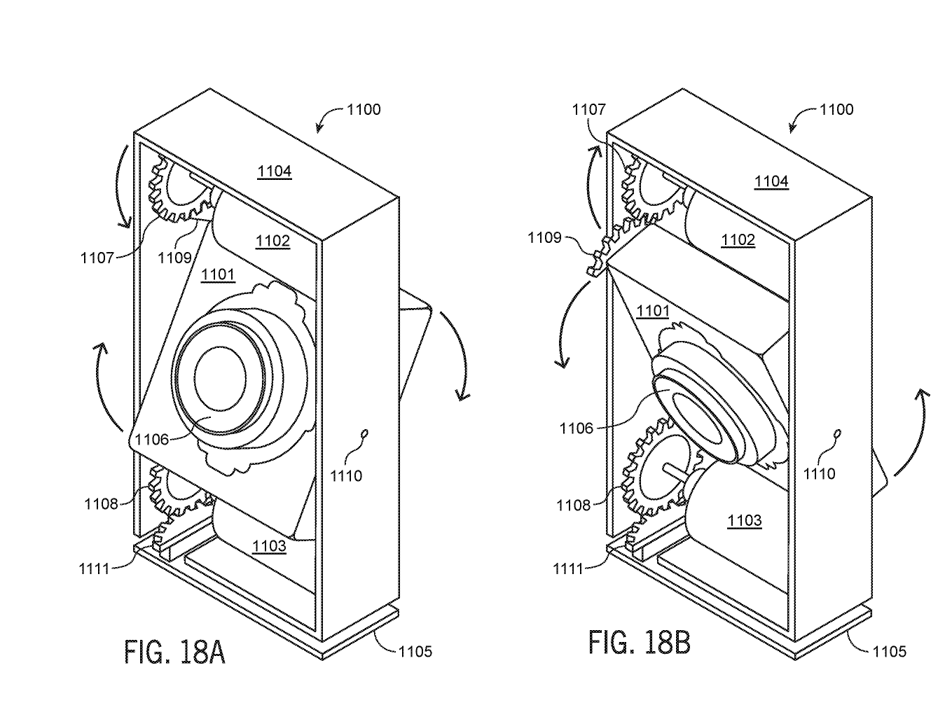

FIGS. 18A and 18B further illustrate the contact between the vertical contact edge 1109 and the tilt actuator gear 1107 of an example of the motion adjustment module 1100, as the primary camera mount 1101 tilts about the primary horizontal axis 1110.

FIGS. 19A and 19B illustrate panning motion of an example of the motion adjustment module 1100. The horizontal contact edge 1111 includes a portion of a circular gear whose radius may originate from the secondary vertical axis 1112. The horizontal contact edge 1111 may be fixed to the tertiary camera mount 1105 so that the pan actuator gear 1108 may be in contact with the horizontal contact edge 1111. This configuration allows the secondary camera mount 1104 to pan left and right upon the secondary vertical axis 1112 through rotation force originating with the pan actuator 1103. This rotation preferably does not exceed a magnitude that would result in loss of contact between the horizontal contact edge 1111 and the pan actuator gear 1108.

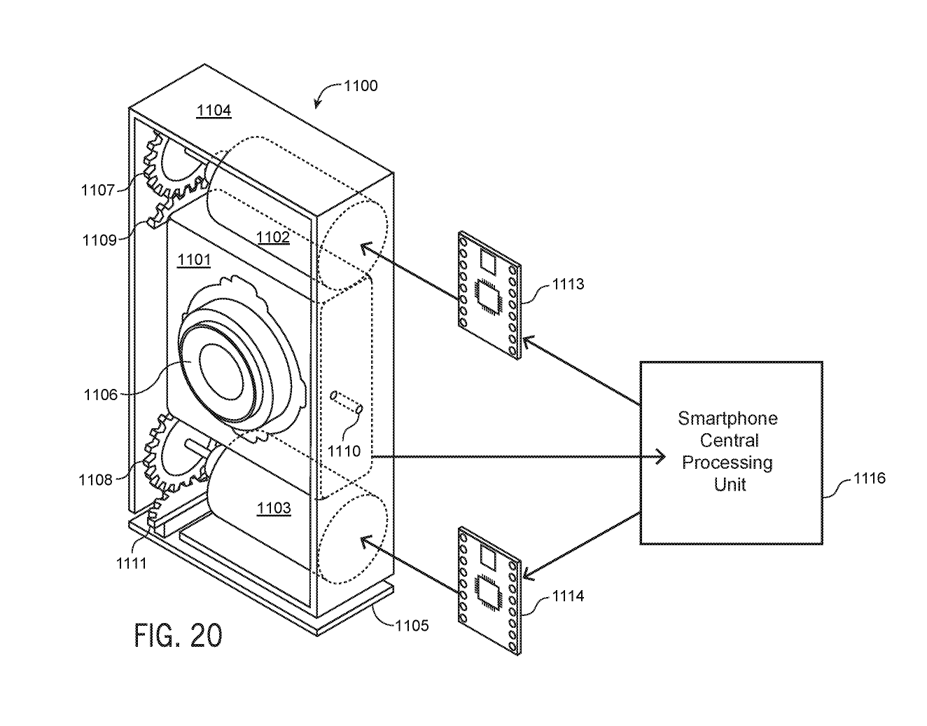

FIG. 20, which is a partial schematic view showing examples of connections involved in an example of a closed loop control system of the motion adjustment module 1100. The control scheme may begin with visual information being sent from the user mobile device camera module 1106 to the user mobile device central processing unit 1116. The visual information may be processed, as previously explained, and an appropriate response signal may be determined by the user mobile device central processing unit 1116. A response signal may be sent independently from the user mobile device central processing unit 1116 to the tilt actuator driver 1113 and/or to the pan actuator driver 1114. The tilt actuator driver 1113 may interpret the tilt response signal, and subsequently send the appropriate step current sequence to the tilt actuator 1102. The pan actuator driver 1114 may interpret the pan response signal and subsequently send the appropriate step current sequence to the pan actuator 1103 causing rotation in the actuator. This rotation alters the visual information sent from the user mobile device camera module 1106 to the user mobile device central processing unit 1116, and the process then repeats.

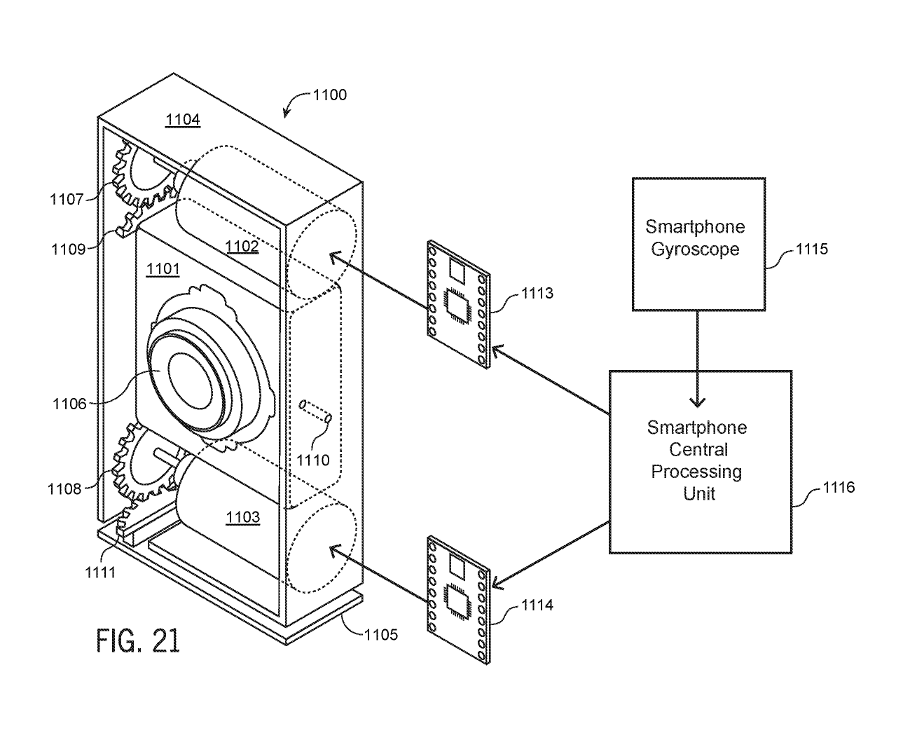

FIG. 21 shows an example of connections involved in an example of an open loop control system for the motion adjustment module 1100. The control scheme may begin with three-dimensional orientation information being sent from a user mobile device 270 acceleration sensor 1115 to the user mobile device central processing unit 1116. The orientation information may be processed, as previously explained, and an appropriate response signal may be determined. A response signal may then sent independently from the user mobile device central processing unit 1116 to the tilt actuator driver 1113 and/or to the pan actuator driver 1114. The tilt actuator driver 1113 may interpret the tilt response signal and subsequently send the appropriate step current sequence to the tilt actuator 1102. The pan actuator driver 1114 may interpret the pan response signal and subsequently send the appropriate step current sequence to the pan actuator 1103.

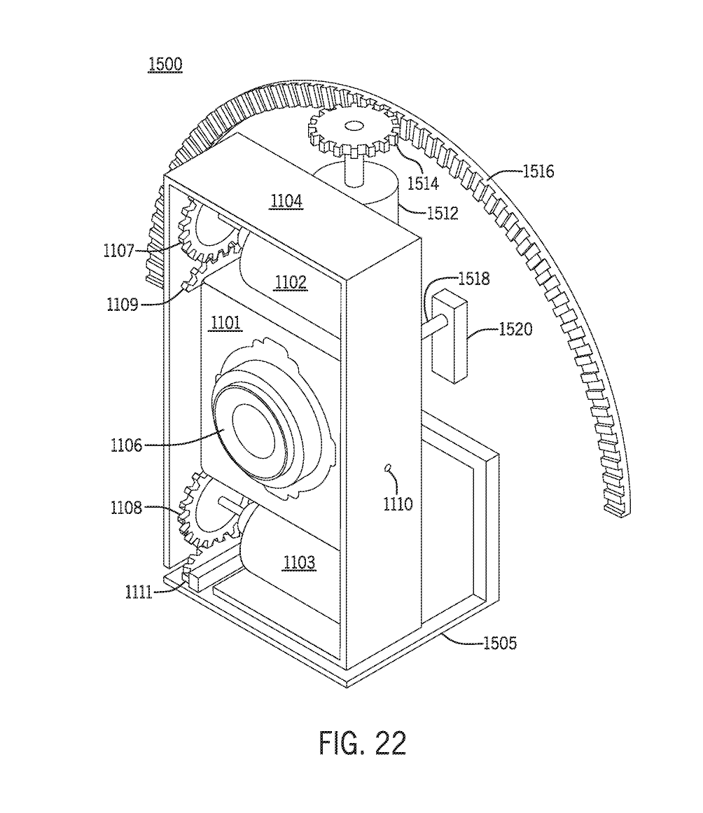

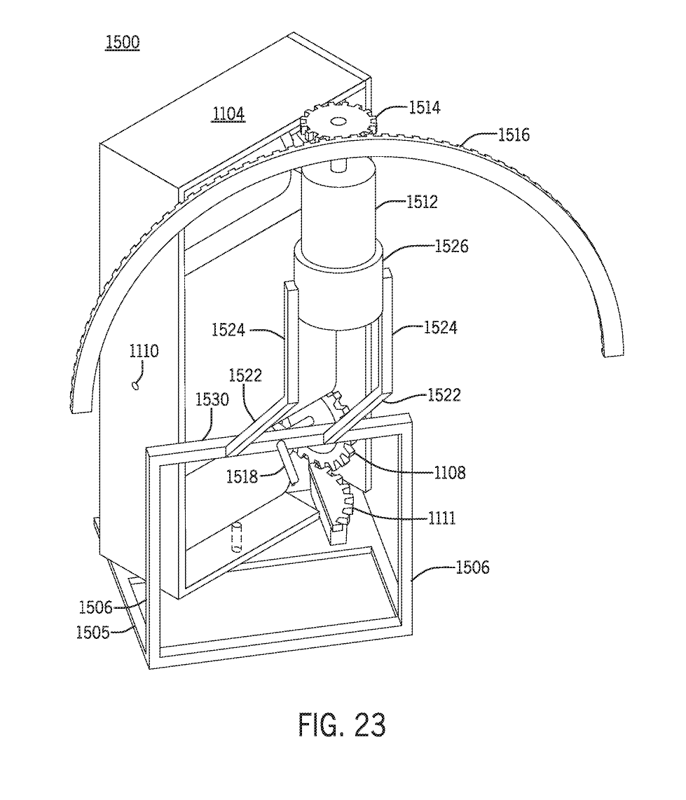

FIGS. 22 and 23 show another example of a motion adjustment module 1500. The motion adjustment module 1500 includes an additional actuator 1512, driving portion 1514, and driven portion 1516 enabling rotation of the camera 1106 about a third axis. The motion adjustment module 1500 may include a tertiary mount 1505 with a mounting shaft 1518 and a mount 1520 to allow attachment of the motion adjustment module 1500 to a user mobile device 270. The tertiary mount 1505 may have one or more upright legs 1506 extending from the tertiary mount toward the camera 1101. The upright legs 1506 may be connected by a cross-beam 1530. The cross-beam 1530 may have one or more actuator support legs 1522, 1524 extending upward toward the actuator 1512. An actuator receiving feature 1526 may be coupled to one or more of the actuator support legs 1524. The user mobile device central processing unit 1116 may activate the actuator 1512 to rotate the tertiary mount 1505, and ultimately the camera 1101 in order to execute the methods and operations disclosed.

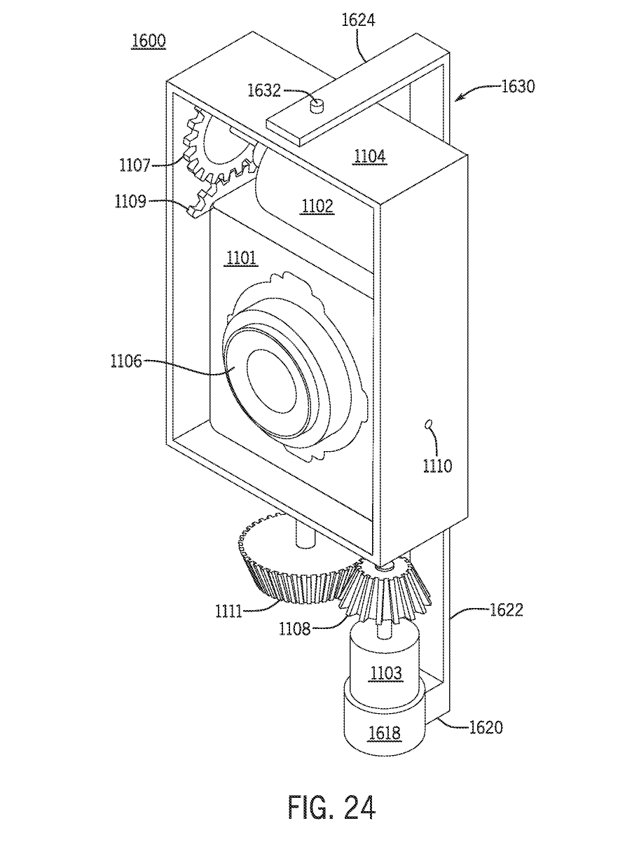

FIG. 24 illustrates another example of a motion adjustment module 1600. The motion adjustment module 1600 includes another example of a secondary mount driven portion 1111, a secondary mount driving portion 1108, a secondary mount actuator 1103. The actuator 1103 is held in an actuator receiving feature 1618. The motion adjustment module 1600 includes a tertiary mount 1630 extending from the actuator receiving feature 1618 at one end of the motion adjustment module 1600 to an opposite end of the motion adjustment module 1600. The tertiary mount 1630 includes a lateral actuator offset portion 1620 connecting the actuator receiving feature 1618 to a central spine 1622. The central spine 1622 runs along a dimension of the motion adjustment module 1600. The central spine 1622 connects to a lateral support member 1624 extending from the spine 1622 to the secondary mount 1604. The lateral support member 1624 is pivotally connected to the secondary mount 1604 at pivot 1632.

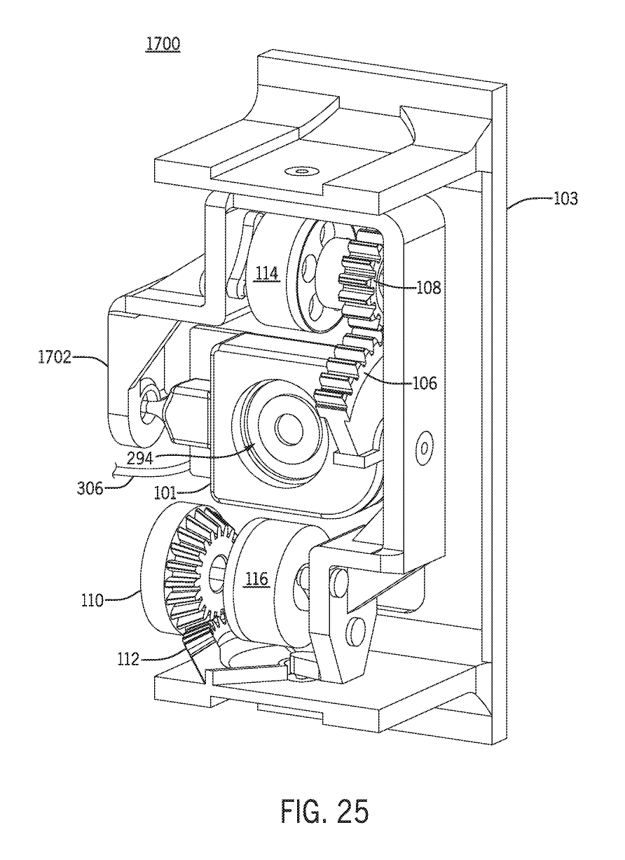

FIGS. 25, 26, 27A-27E illustrate another example of a motion adjustment module 1700. The motion adjustment module 1700 includes similar components to motion adjustment module 100, and is assembled and operates in a similar fashion. The motion adjustment module 1700, uses different examples of certain components, as well as additional components. The motion adjustment module 1700 includes a primary mount driven portion 106 with an arc length subtending less than 180 degrees. The motion adjustment module 1700 includes a plurality of actuator fasteners 1720. In various examples, the actuator fasteners 1720 are screws, pins, rivets, bolts, nuts, or the like. The motion adjustment module 1700 includes primary mount bearings 1722a and 1722b cooperating with shafts 122 and 120, and bearing surfaces 1762, 1760 of secondary mount 1702 to provide rotational or pivotal coupling between the primary mount 101 and the secondary mount 1702. The motion adjustment module 1700 includes secondary mount bearings 1724a and 1724b that cooperating with shafts 1752, 1750, and bearing surfaces 198, 200 to provide rotational or pivotal coupling between the secondary mount 1702 and the tertiary mount 103.

FIGS. 27A-27E illustrate various views of an example of a secondary mount 1702 of the motion adjustment module 1700. The secondary mount 1702 is an example of the flexibility of form of the secondary mount, allowing for routing of the various wires, cables, or circuit boards of the communications link 306. The secondary mount 1702 has a structural spine 1754. The spine 1754 has a pivot shaft 1752 at one end, extending through pivot axis B-B. The pivot shaft 1752 extends from a lateral pivot arm 1788 of the spine 1754 in a direction parallel to the pivot axis B-B. The lateral pivot arm 1788 extends perpendicular to the pivot axis B-B and connects to vertical arm 1779. The vertical arm 1779 has a secondary mount actuator receiving feature 1787. The secondary mount actuator receiving feature 1787 extends parallel to the pivot axis B-B and has a plurality of actuator mount apertures 1713 that receive actuator fasteners 1720 and hold the actuator 116. The secondary mount actuator receiving feature 1787 has an aperture 1776 to accept mounting features of the actuator 114. The secondary mount actuator receiving feature 1787 connects to a lateral arm 1786 extending perpendicular to the pivot axis B-B. The lateral arm 1786 and the secondary mount actuator receiving feature 1787 are connected with a stiffening gusset 1703. The lateral arm 1786 connects to a main beam 1780 extending parallel to the pivot axis B-B. The lateral arm 1786 and main beam 1780 are connected with a stiffening gusset 1705. The main beam 1780 connects to a main upper lateral 1783 extending perpendicular to the pivot axis B-B. A pivot shaft 1750 extends from the main upper lateral 1783 parallel to the pivot axis B-B. A hanging arm 1778 extends from the main upper lateral 1783 toward the pivot shaft 1752, parallel to the pivot axis B-B.. The hanging arm 1778 has a primary mount actuator receiving feature 1781 to receive and hold an actuator for the primary mount 101. The primary mount actuator receiving feature 1781 has a plurality of actuator mount apertures 1711 that receive actuator fasteners 1720, and hold the actuator 114. A lateral arm 1782 extends from the primary mount actuator receiving feature 1781 in a direction perpendicular to the pivot axis B-B. A stiffening gusset 1707 extends between the primary mount actuator receiving feature 1781 and the lateral arm 1782. A hanging arm 1784 extends from the lateral arm 1782 in a direction parallel to the pivot axis B-B. The lateral arm 1782 and hanging arm 1784 are connected by a stiffening gusset 1709.

The hanging arm 1784 has a first primary mount pivot aperture 1761. The spine 1780 has a second primary mount pivot aperture 1763. The apertures 1761 and 1761 extend along the pivot axis A-A. The first and second primary mount pivot apertures 1761, 1763 may be substantially cylindrical holes extending through a thickness of the hanging arm 1784 and the main support frame 1780, respectively. The first and second primary mount pivot apertures 1761, 1763 may have first and second bearing surfaces 1760 and 1762, respectively. The bearing surfaces 1760, 1762 may allow for the pivoting and support of a shaft or bearing therein, for example bearings 1722a and 1722b.

The above specifications, examples, and data provide a complete description of the structure and use of exemplary examples of the invention as defined in the claims. Although various examples of the disclosure have been described above with a certain degree of particularity, or with reference to one or more individual examples, those skilled in the art could make numerous alterations to the disclosed examples without departing from the spirit or scope of the claimed invention. Other examples are therefore contemplated. It is intended that all matter contained in the above description and shown in the accompanying drawings shall be interpreted as only illustrative of particular examples and not limiting. Changes in detail or structure may be made without departing from the basic elements of the invention as defined in the following claims.

All relative and directional references (including: upper, lower, upward, downward, left, right, leftward, rightward, top, bottom, side, above, below, front, middle, back, vertical, horizontal, right side up, upside down, sideways, and so forth) are given by way of example to aid the reader's understanding of the particular examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

I claim:

1. A method of adjusting a field of view of a camera in a mobile device during image capture, the method comprising:
detecting by a processing element an object within an image captured by the camera;
determining by the processing element an object boundary surrounding the object;
determining by the processing element a position of the object boundary relative to an image frame;
determining by the processing element a distance from the object boundary to a selected region;
comparing by the processing element the distance to a distance threshold, and based on the comparison;
outputting by the processing element a control signal to adjust a physical position of the camera; and
recording by the processing element a position of the actuator.

2. The method of claim 1, wherein the adjustment of the physical position of the camera corresponds to movement of the object within the image.

3. The method of claim 1, wherein the processing element detects the object based on a pattern.

4. The method of claim 1, further comprising:
determining by the processing element a velocity of the object relative to the image frame;
comparing by the processing element the velocity to a velocity threshold; and
adjusting further by the processing element the position of the camera with an actuator.

5. The method of claim 2, further comprising:
outputting the control signal to a first actuator, wherein the control signal is based on the comparison of the distance to the distance threshold; and
rotating the first actuator, wherein the first actuator rotates a first mount holding a camera to compensate for the movement of the object within the image.

6. The method of claim 5, further comprising:
outputting the control signal to a second actuator, wherein the control signal is based on the comparison of the distance to the distance threshold; and
rotating the second actuator, wherein the second actuator rotates a second mount holding the first mount and the camera to compensate for the movement of the object within the image.

7. The method of claim 6, wherein the second mount holds the second actuator.

8. The method of claim 6, wherein the first actuator and the second actuator rotate about parallel axes.

9. The method of claim 1, further comprising:
receiving rotation data by a processing element from an acceleration sensor;
setting an initial rotation data;
determining a current rotation data;
determining a change in the rotation data; and
comparing the change in rotation data to a threshold, and based on the comparison, adjusting the image.

10. A method to maintain a selected object within a field of view of a camera in a mobile device, the method comprising:
detecting by a processing element, an object within an image captured by the camera;
tracking by a processing element a distance of the object relative to an image boundary;
outputting a movement signal to a first actuator on a first mount, wherein the first mount tilts or pans the camera; and
moving the first actuator to adjust a position of the camera to keep the object within the image boundary.

11. The method of claim 10, wherein a second mount holds the first mount, the first actuator and a second actuator.

12. The method of claim 11, wherein the second actuator tilts or pans the second mount to keep the object within the image boundary.
